(19) United States
(12) Patent Application Publication
(10) Pub. No.: US 2013/0191168 A1
(43) Pub. Date: Jul. 25, 2013

(54) SYSTEM, METHOD, AND COMPUTER READABLE MEDIUM FOR COORDINATING INSURANCE APPLICANT INTERVIEWS

(71) Applicant: Paul Klimek, Boca Raton, FL (US)

(72) Inventor: Paul Klimek, Boca Raton, FL (US)

(73) Assignee: Apptical Corp., Boca Raton, FL (US)

(21) Appl. No.: 13/558,090

(22) Filed: Jul. 25, 2012

Related U.S. Application Data
(60) Provisional application No. 61/511,190, filed on Jul. 25, 2011.

(51) Int. Cl. G06Q 40/08

(52) U.S. Cl. CPC G06Q 40/08
USPC 705/4

(57) ABSTRACT

A system, method, and computer readable medium for enabling the receipt of data for an insurance application. More particularly, a mechanism enabled to configure an insurance application into a product questionnaire, to present the product questionnaire via an interface to enable an individual to input disclosure data obtained from an insurance applicant, and to provide the received disclosure data in an industry standard format.

### FIELD

The present invention generally pertains to obtaining data for an insurance application. More particularly, the present invention pertains to a system configured to ensure the proper receipt of application data.

### BACKGROUND

Insurance underwriting companies employ personnel known as “interviewers” to obtain insurance application data (“disclosure data”) from individuals seeking insurance coverage. For example, an interviewer may speak with an insurance agent and an applicant over the phone to obtain disclosure data. Training interviewers is a costly and time consuming endeavor. New personnel must learn industry terminology, the requirements of each individual insurance policies or services (herein referred to as “products”), and any variations for such products. For example, a product's requirements may differ based upon an applicant's state of residence. This training may delay the deployment of an insurance product, which may be problematic and frustrating for the underwriting company and its clients.

Interviewers typically work from electronic questionnaires designed to enable the interviewer to obtain all disclosure data required for a particular product. As insurance products can vary greatly, the underwriting company may need to employ a computer programmer to create each product's questionnaire. This also is costly, time consuming, error prone, and can delay product deployments. Electronic questionnaires can be rigid and not allow an interviewer to communicate ad hoc information directly to the client company regarding the interview results as a whole. Furthermore, a client company may wish to communicate certain product guidelines to the interviewer or have the interviewer ask specific questions of an applicant, and it can be difficult to organize and communicate this information due to the programming required.

It may be difficult to predict how many interviews will be necessary per a particular time period. For example, an interviewer may be scheduled to answer interview requests from insurance agents in the field during a set time period. However, if few insurance agents call during that time frame, the interviewer may in effect be paid for doing nothing. As such, it is difficult for underwriting companies to schedule personnel. Also, interviewers may wander from their work stations during slow hours, thereby possibly missing interview requests while away.

What is lacking is a mechanism that enables an interviewer to conduct an insurance application interview with minimum training, enables the receipt of disclosure data in such a manner as to ensure its completeness, and allow an underwriting company to track interviewer performance.

### SUMMARY

The disclosed subject matter pertains to a system, method, and computer readable medium for enabling the receipt of data for an insurance application. More particularly, the present invention pertains to a mechanism enabled to configure an insurance application into a product questionnaire, to present the product questionnaire via an interface to enable an individual to input disclosure data obtained from an insurance applicant, and to provide the received disclosure data in an industry standard format.

An object of the disclosed subject matter is to provide a system that prompts interviewers with questions specific to the subject product.

An additional object of the disclosed subject matter is to provide a backend system that allows company specific and even product specific queries to be added, edited, and/or removed without programming expertise.

Yet another object of the disclosed subject matter is to provide underwriters statistical information and/or analysis of interviewer performance.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the claims.

### BRIEF DESCRIPTION OF DRAWINGS

In order to describe the manner in which the above-recited and other advantages and features of the disclosed subject matter may be obtained, a more particular description will be rendered by reference to specific embodiments thereof that are illustrated in the appended drawings. Understanding that these drawings depict only typical embodiments of the disclosed subject matter and are not therefore to be considered limiting of its scope, the disclosed subject matter will be described and explained with additional specificity and detail through the use of the accompanying drawings in which:

FIG. 1 depicts a component architecture of an exemplary insurance application management network according to an embodiment;

FIG. 2 depicts an architecture overview of an exemplary insurance application manager mechanism according to an embodiment;

FIG. 3 depicts a flowchart of an exemplary process of a receiving and processing disclosure data according to an embodiment; and

FIG. 4-FIG. 48 depict an exemplary interviewer interface for receiving disclosure data according to an embodiment.

### DESCRIPTION

Various embodiments of the disclosed subject matter are discussed in detail below. While specific implementations are discussed, this is done for illustration purposes only. A person of ordinary skill in the relevant art will recognize that other components and configurations may be used without departing from the spirit and scope of the invention.

The disclosed subject matter described here is typically described in relation to life insurance; however this is not to be construed as limiting. The system and methodology presented herein may also be applicable to other scenarios, such other types of insurance (e.g., health insurance, automobile insurance, home insurance, etc.) or any situation in which application data is received and analyzed.

An “applicant” as used herein may be an individual seeking an insurance policy with a client company. The term “client company” as used herein may be an insurance company or an insurance company affiliate. An “agent” as used herein may be an individual representing an insurance company or insurance company affiliate. An “interviewer” as used herein may be an employee of insurance application data management system (IADMS) service and may be responsible for obtaining disclosure data from an applicant and/or agent. An “administrator” as used herein may be an IADMS service employee that has authorization to configure IADMS functionality, monitor interviewer performance, etc. It is to be understood that such roles are not exclusive and, for example, an administrator may be an interviewer with administrative authorization.

### Insurance Application Network

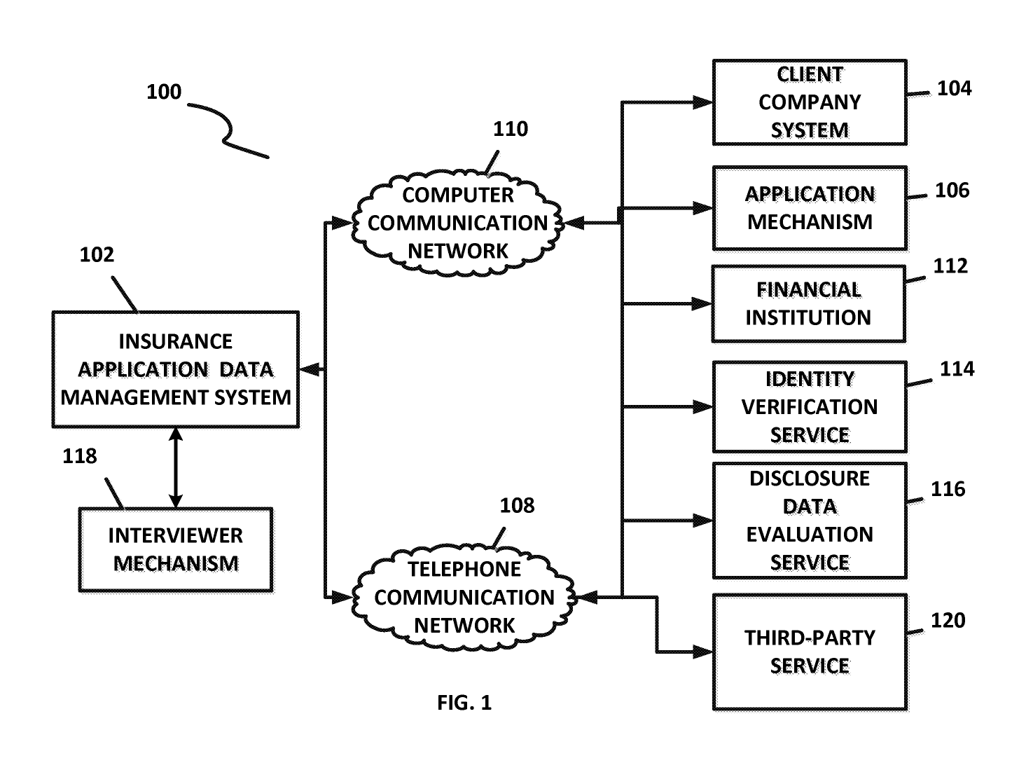

FIG. 1 depicts a component architecture of an exemplary embodiment of an insurance application network 100. Insurance application network 100 may include one or more components to enable insurance application processes, such as insurance application data management system (IADMS) 102, client company system 104, application mechanism 106, financial institution 112, identity verification service 114, disclosure data evaluation server 116, interviewer mechanism 118, and third-party service 120.

Those with ordinary skill in the art will recognize that the logical components set forth in FIG. 1 are merely exemplary and that other configurations that provide substantially similar functionality to that of the logical components in FIG. 1 may be used consistent with the scope of the disclosed subject matter. Although only a single instance of each component is depicted, this is for illustrative purposes only and is not to be construed as limiting. For example, insurance application network 100 may include multiple client company systems 104, application mechanism 106, financial institutions 112, identity verification services 114, disclosure data evaluation services 116, and third-party services 120. Additionally, it is to be understood that applicants and/or agents may be associated with one or more application mechanisms 106 and interviewers may be associated with one or more interviewer mechanisms 118. Although each component is depicted and described as separate, this is not to be construed as limiting, and components may be combined per implementation. For example, IADMS 102 may include disclosure data evaluation service 116. As appropriate, IADMS 102, client company system 104, application mechanism 106, financial institution 112, identity verification service 114, disclosure data evaluation service 116, interviewer mechanism 118, third-party service 120 and their associated components may each include one or more of a computer server, a computer processor, electronic components, such as a storage medium, a server, a database, etc, which may be used for processing, storing, transmitting and/or receiving data.

One or more of the components of the network may communicate via telephone communication network 108 and/or computer communication network 110. Telephone communication network 108 may be any applicable telephony network capable of relaying telephone-based communications, such as a plain old telephone service (POTS) network, a mobile telephony network, integrated services digital network (ISDN), etc. Furthermore, telephone communication network 108 may enable text-based messaging, such as short message service (SMS) text messaging. Computer communication network 110 may be any applicable electronic network capable of relaying data messages from one computerized mechanism to another, such as the Internet or a mobile data network. A data message may be, for example, an email, an instant message, Web site data, etc. Computer communication network 110 may include one or more of a local area network (LAN), a personal area network (PAN), a wireless local network (WLAN), a wide area network (WAN), a wireless personal network (WPAN), etc.

IADMS 102 may be a computerized mechanism enabled to receive and distribute data associated with an insurance application, such as product requirement data and disclosure data. IADMS 102 may receive product requirement data from client company system 104. Client company system 104 may include a client company's application system and may be configured to communicate product requirement data to IADMS 102 and to receive disclosure data from IADMS 102.

Product requirement data may detail the disclosure data a client company requires an applicant provide in order for the applicant to apply for one or more of the client company's products, such as information regarding an applicant's contact information, medical history, prescription history, family history, physical characteristics, etc. Product requirement data may also include one or more supplemental questions particular to a product. As the IADMS service provider may serve multiple insurance agencies, IADMS 102 may receive product requirement data from more than once client company system 104. In one embodiment, product requirement data may be provided from client company system 104 via a data transmission, such as via email. Alternatively, a client company may provide product requirement data by accessing a Web site and providing the data via a Web interface (e.g., an online form), by uploading a data file, etc. Once IADMS 102 has received the product requirement data, it may be stored in a client company record. The product requirement data may be automatically stored or may be manually entered by IADMS personnel.

IADMS 102 may be enabled to receive disclosure data from an applicant and/or agent via application mechanism 106. Disclosure data may include information provided by an applicant in response to the details of a product's product requirement data (e.g., contact information, medical history data, prescription data, family history data, physical characteristic data, answers to supplemental questions, etc.). Disclosure data may be stored in an applicant record. If necessary, IADMS 102 may convert the received disclosure data into a format usable by client company system 104. For example, disclosure data may be converted into Extensible Markup Language (XML) format that is Association for Cooperative Operations Research and Development (ACORD) or Health Insurance Portability and Accountability Act (HIPAA) compliant.

Application mechanism 106 may be any appropriate mechanism that enables an applicant and/or an agent to provide disclosure data to IADMS 102. An application mechanism 106 may be a standard telephone, a mobile device (e.g., a mobile phone or a smartphone), a personal computer (e.g., a desktop computer, a laptop computer, a tablet computer, etc.), etc. Application mechanism 106 may be configured to communicate with IADMS 102 via computer communication network 110 and/or telephone communication network 108, as would be appropriate per the particulars of the application mechanism 106 employed. For example, an applicant and/or agent may use a telephone to provide disclosure data via telephone communication network 108 or may use a personal computer to provide disclosure data via computer communication network 110.

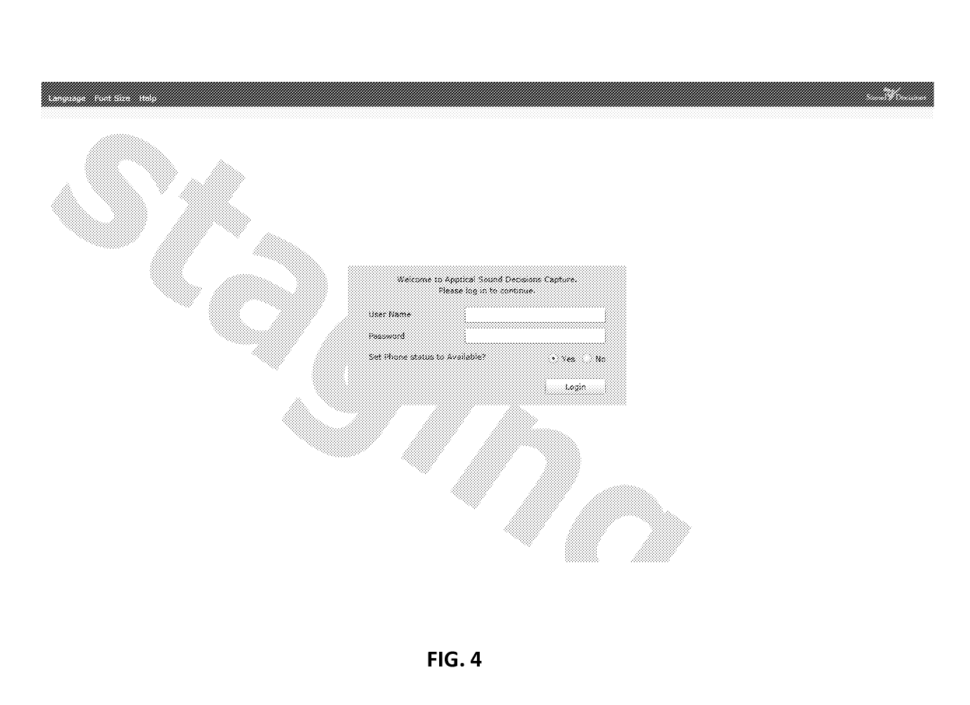

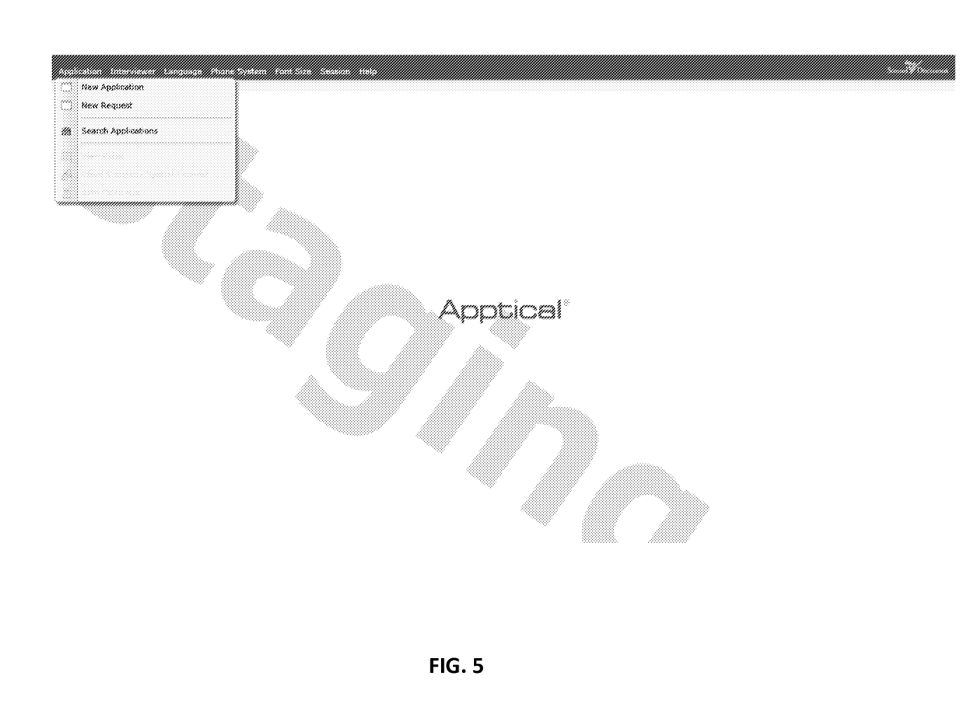

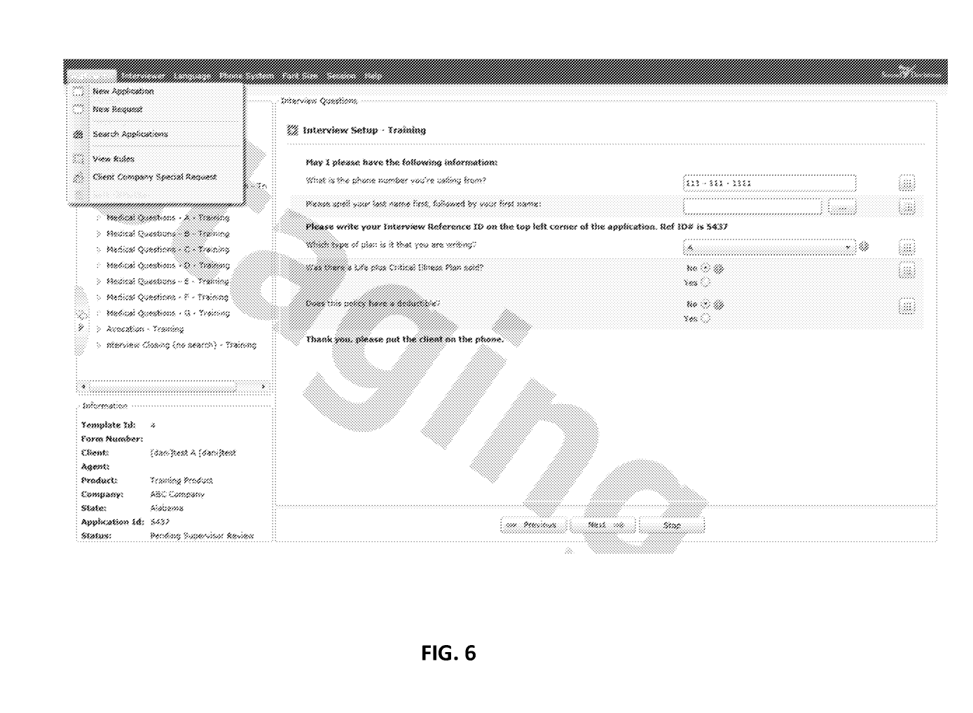

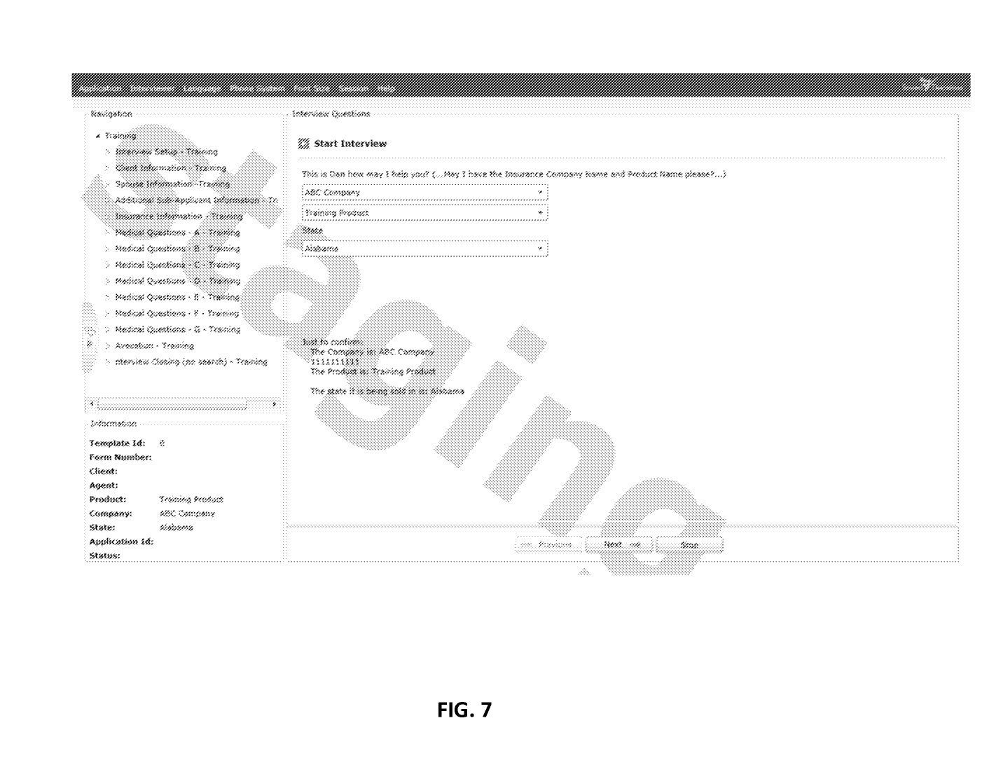

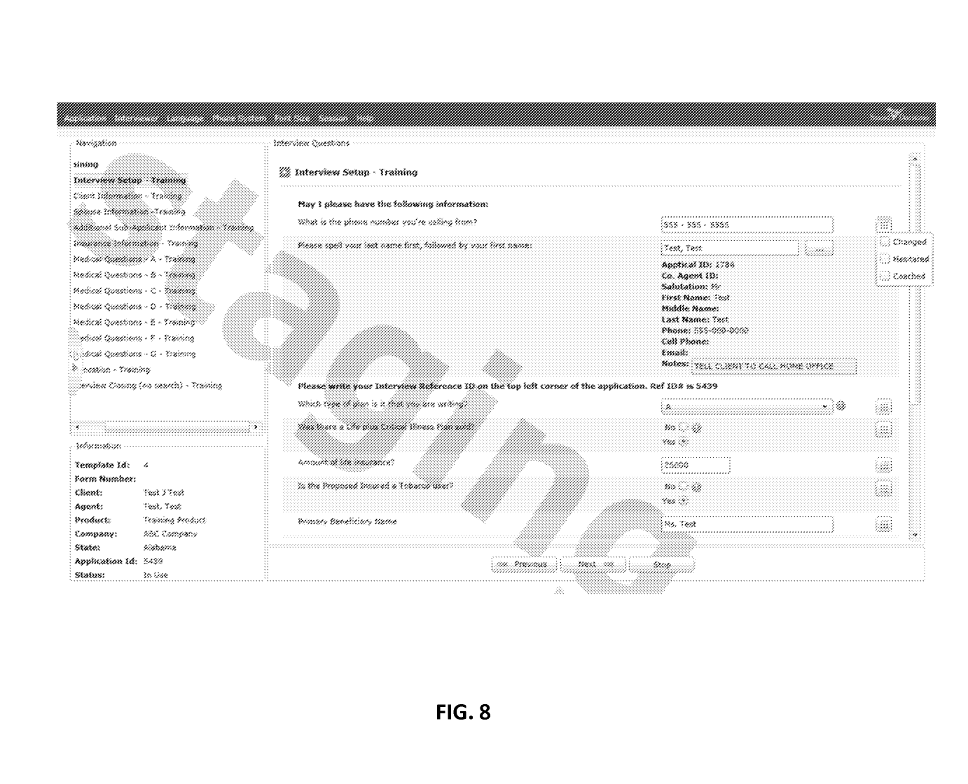

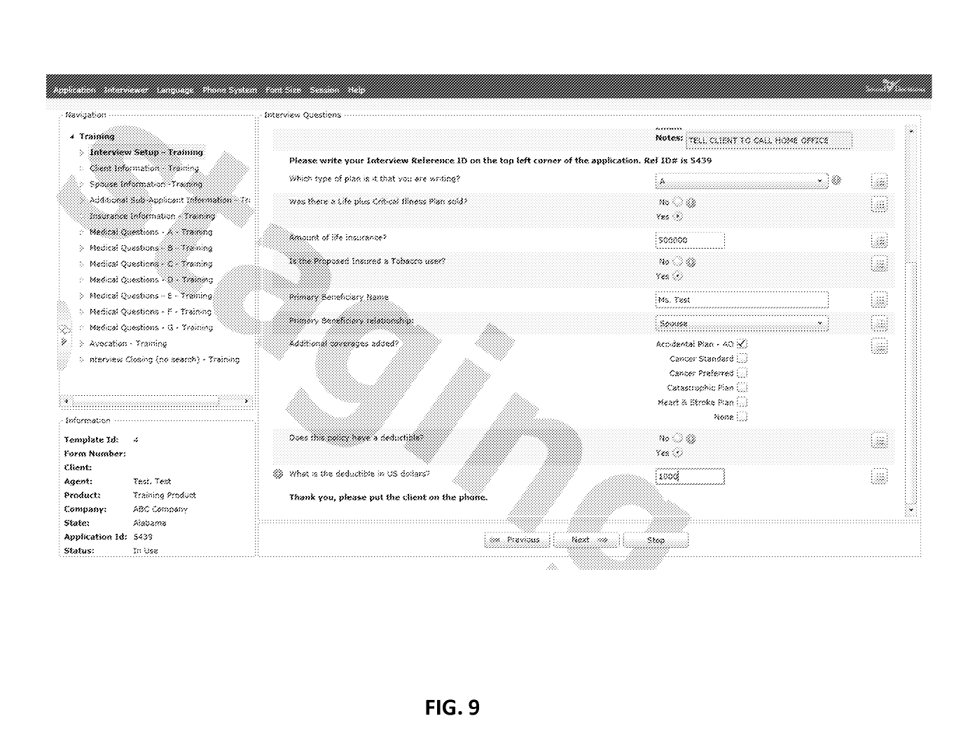

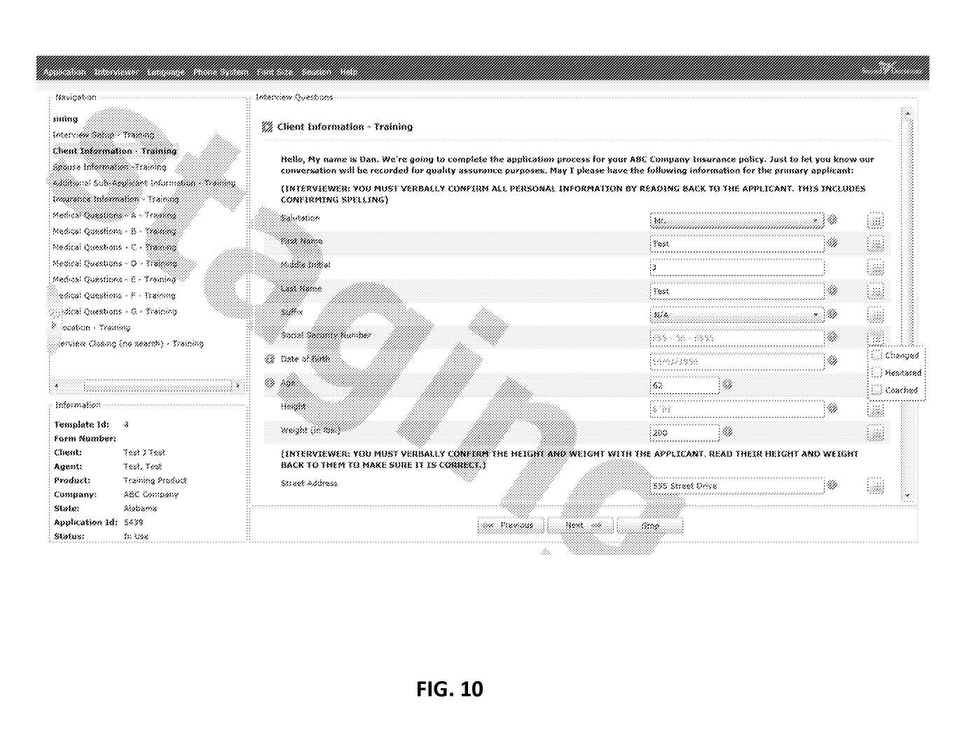

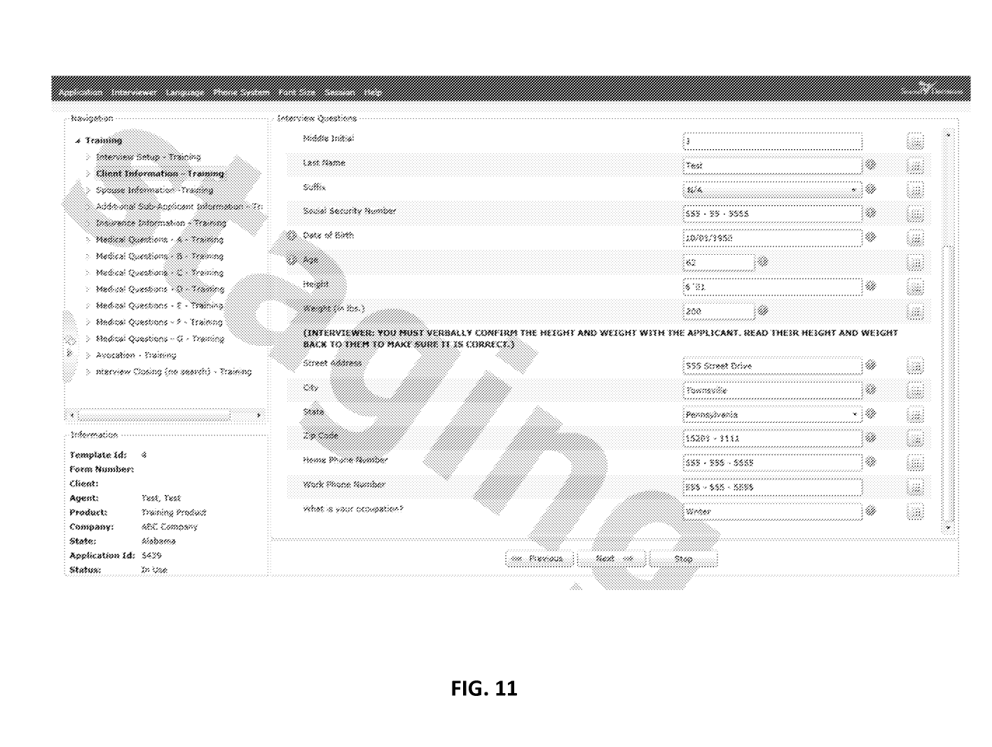

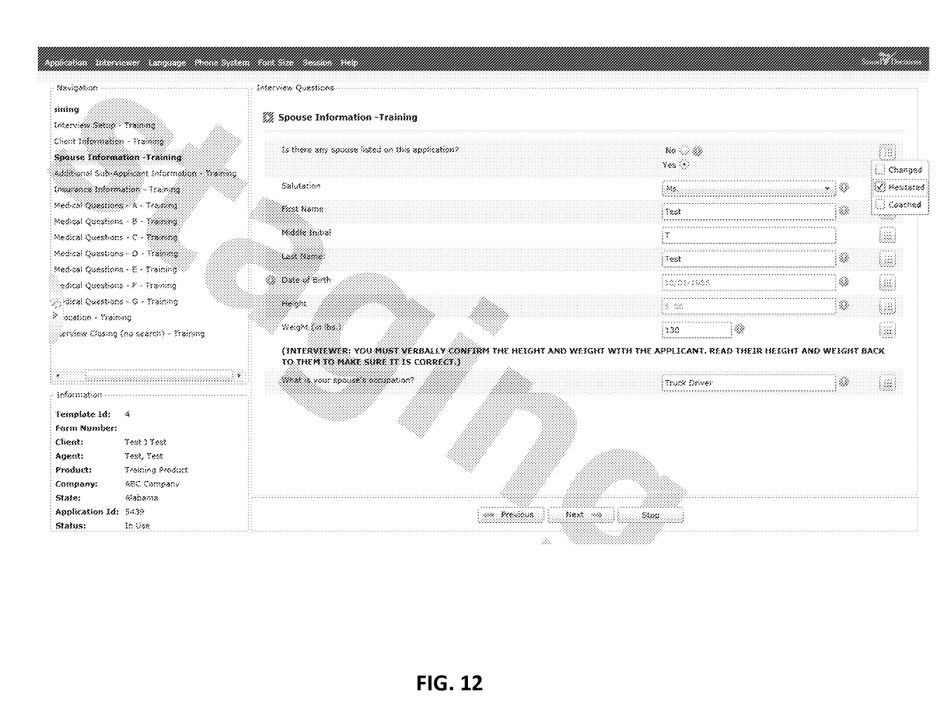

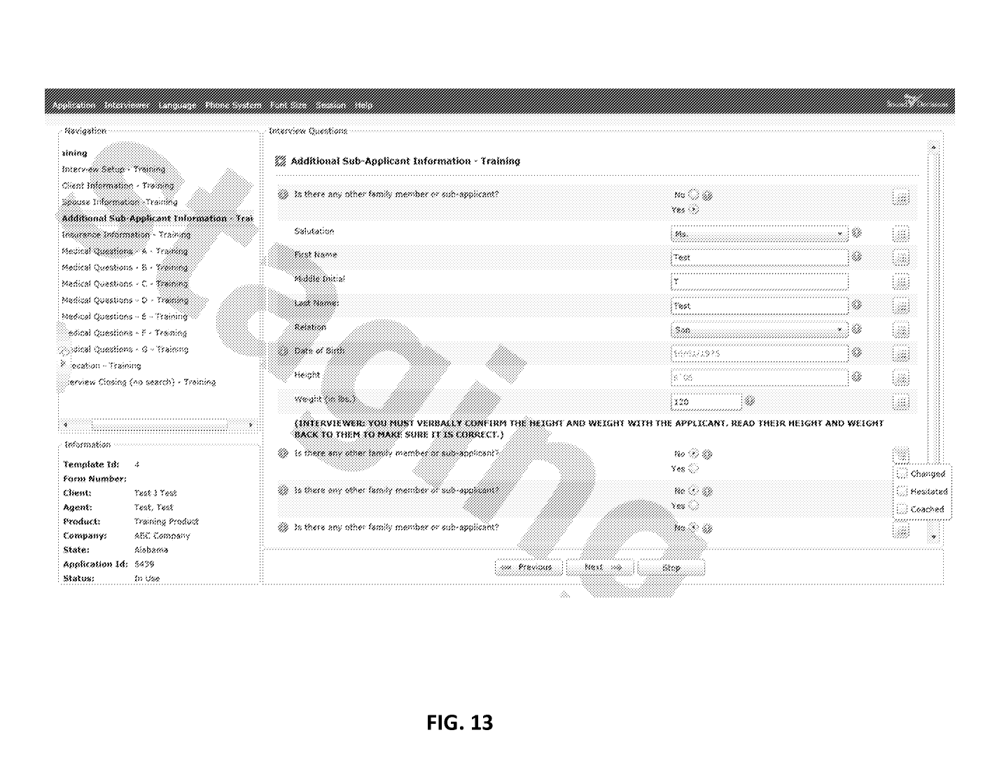

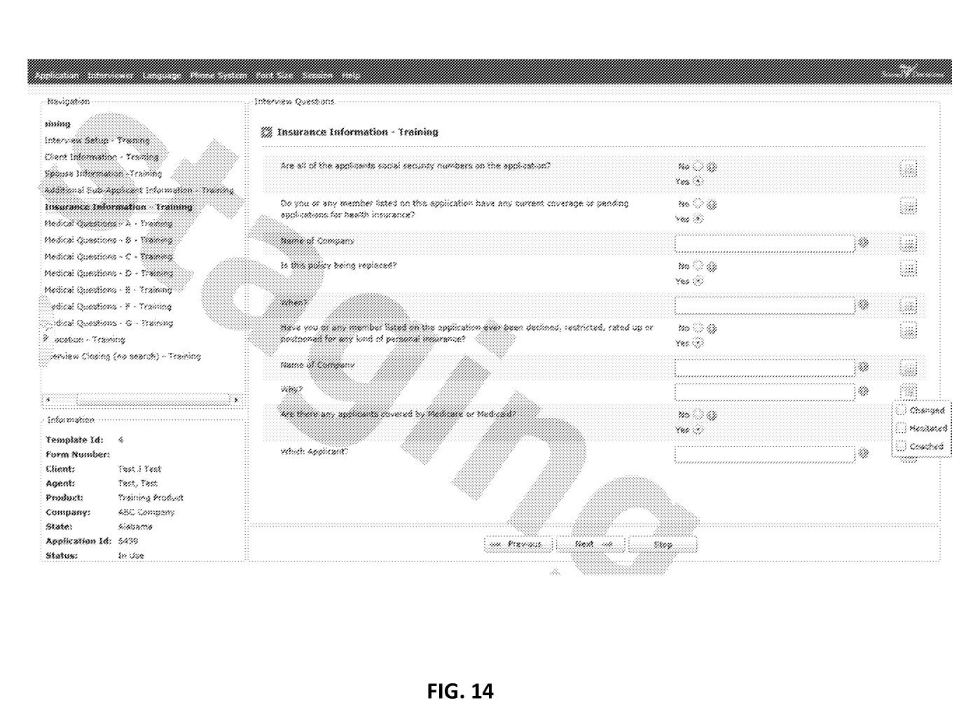

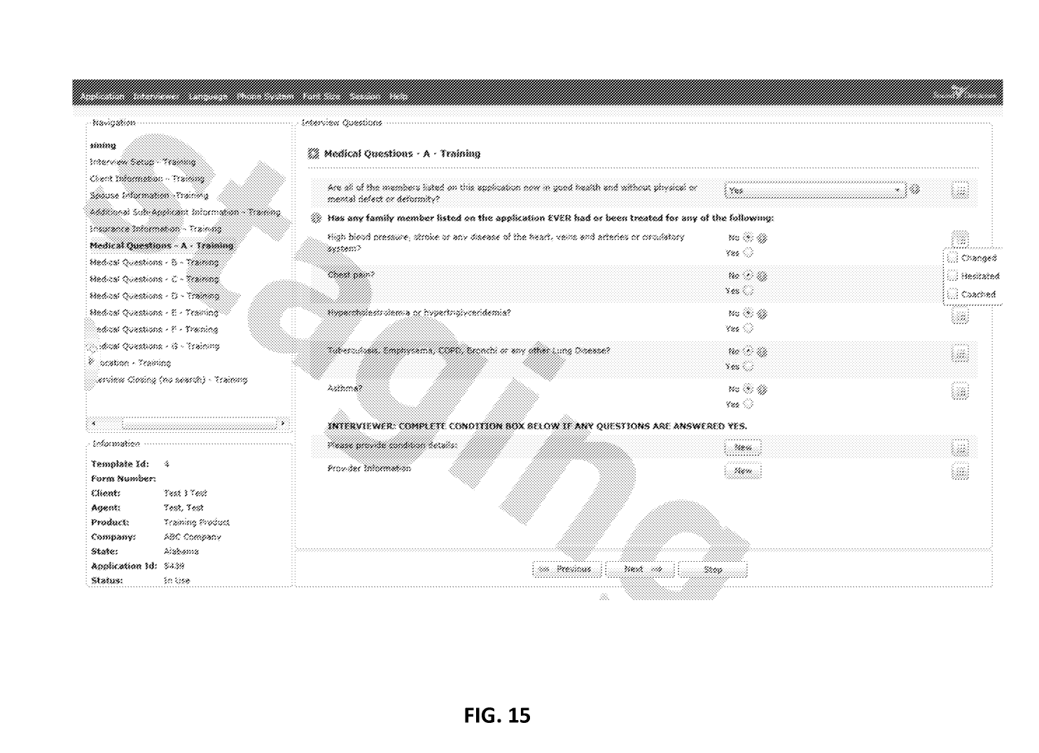

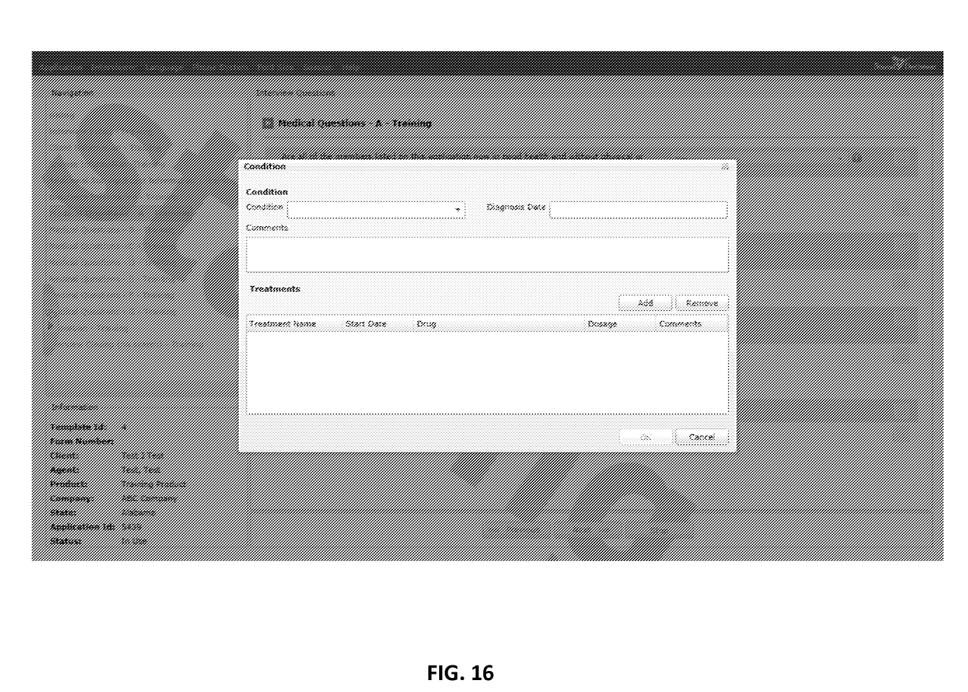

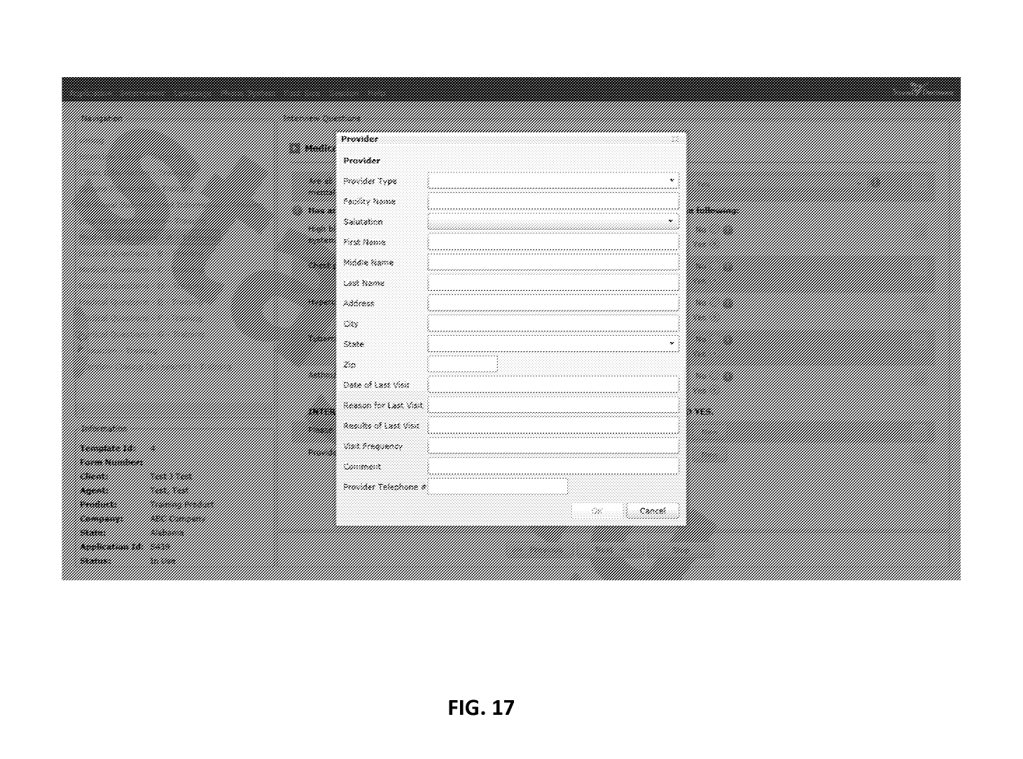

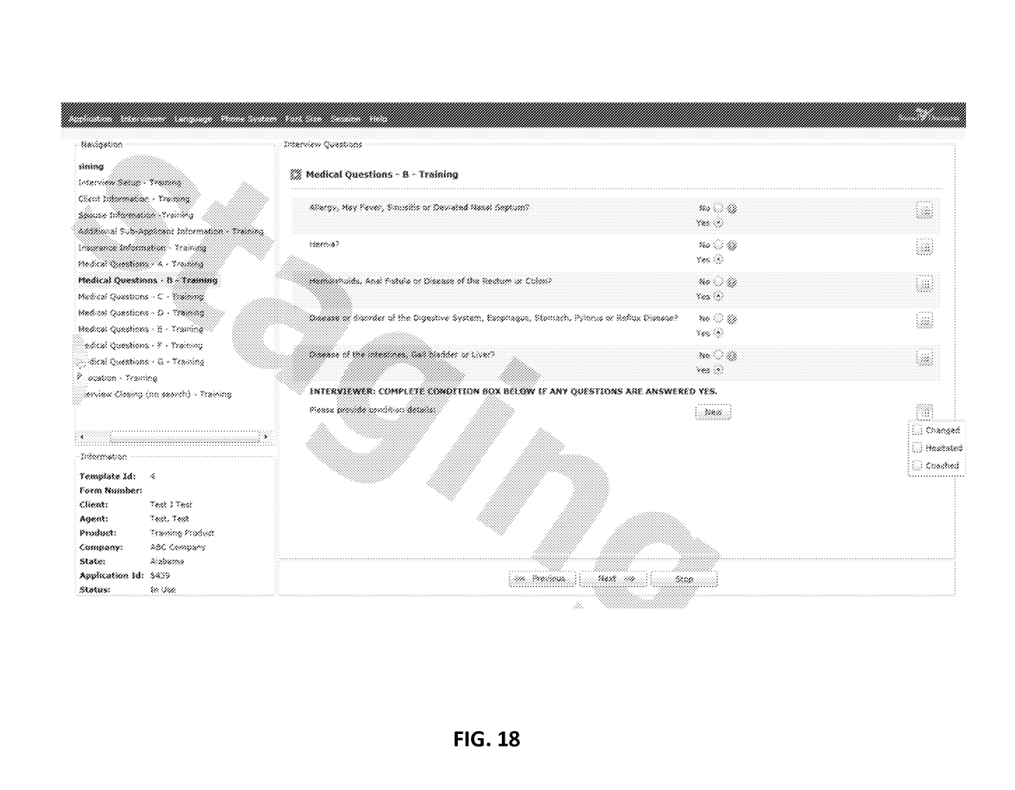

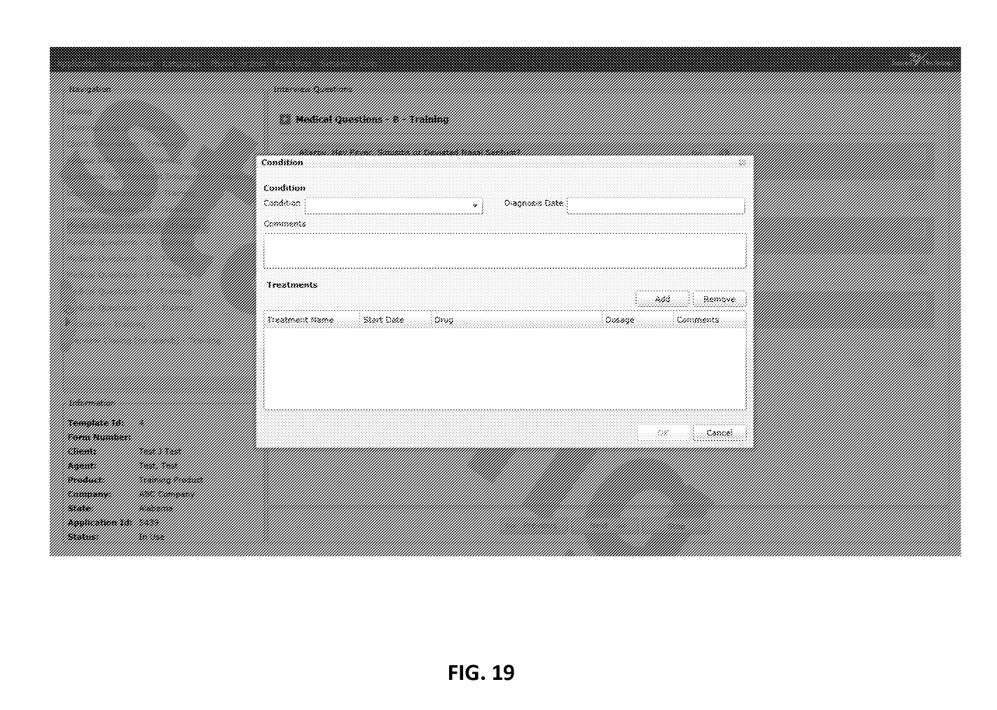

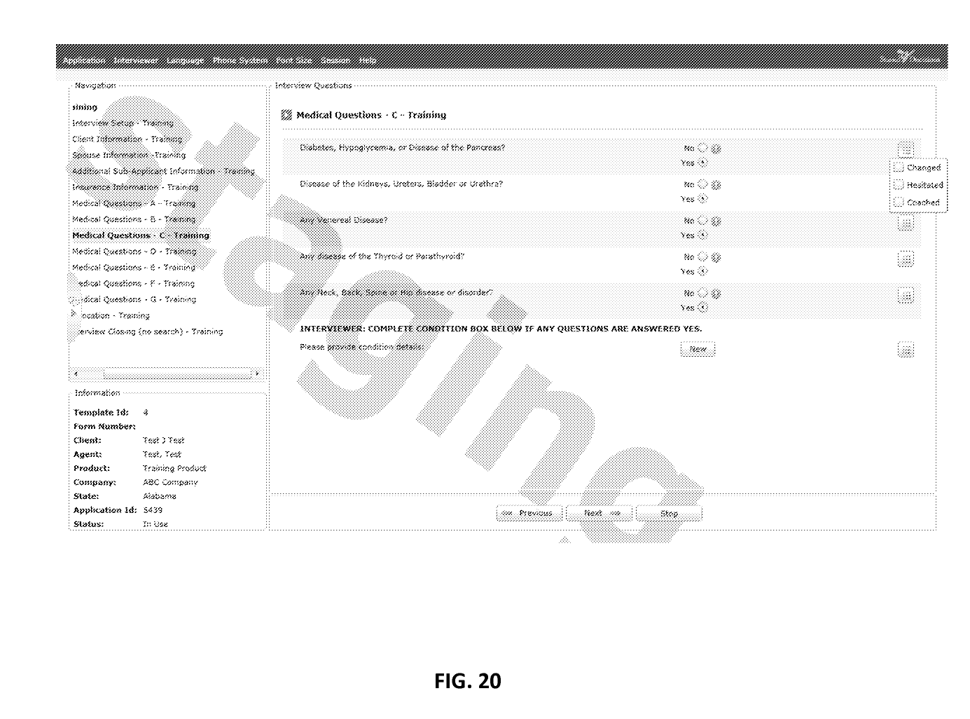

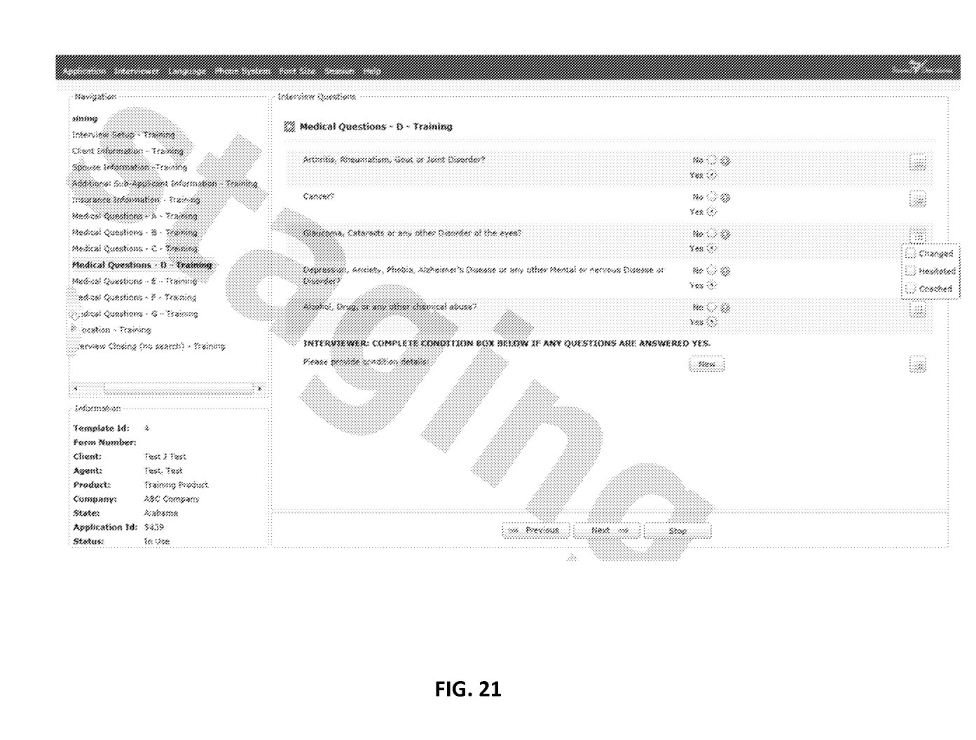

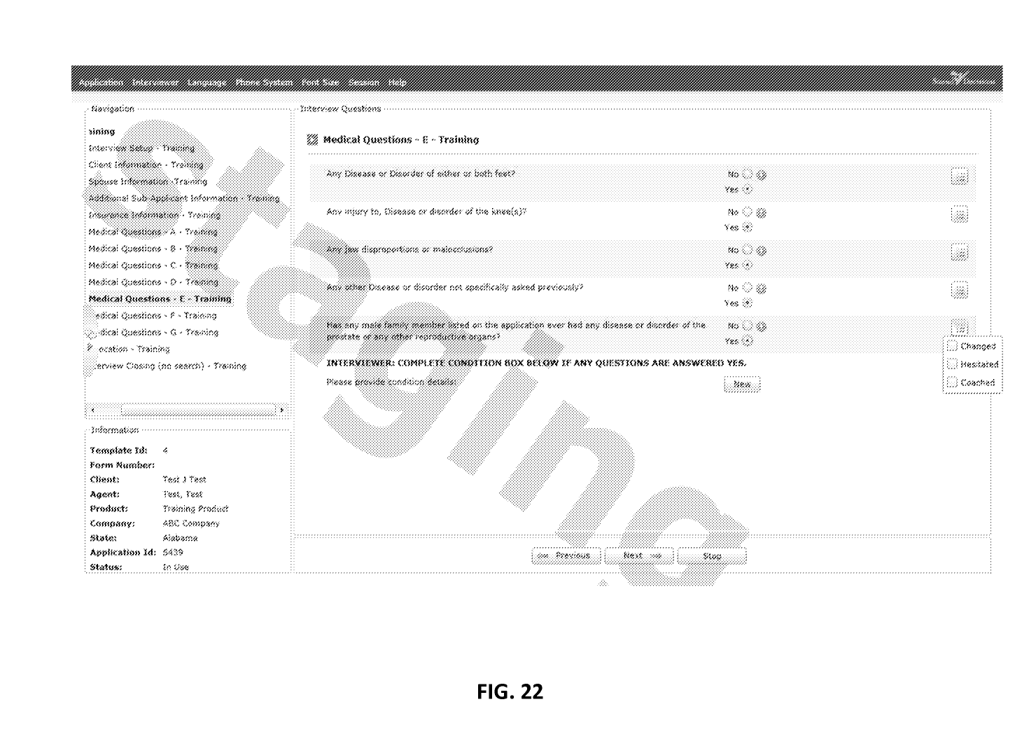

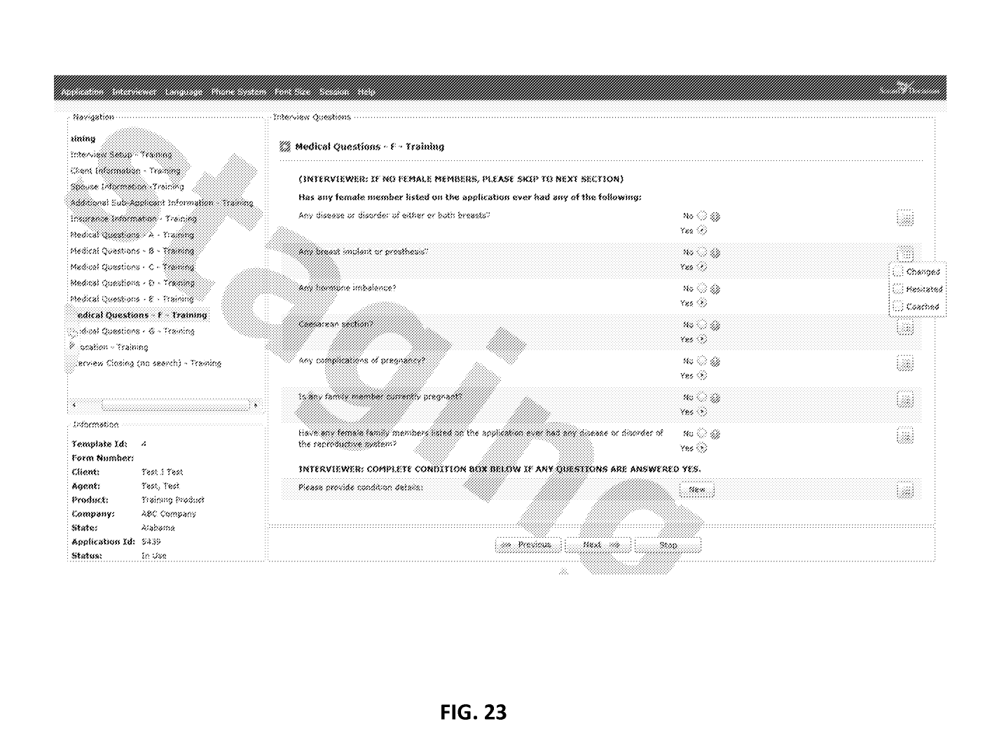

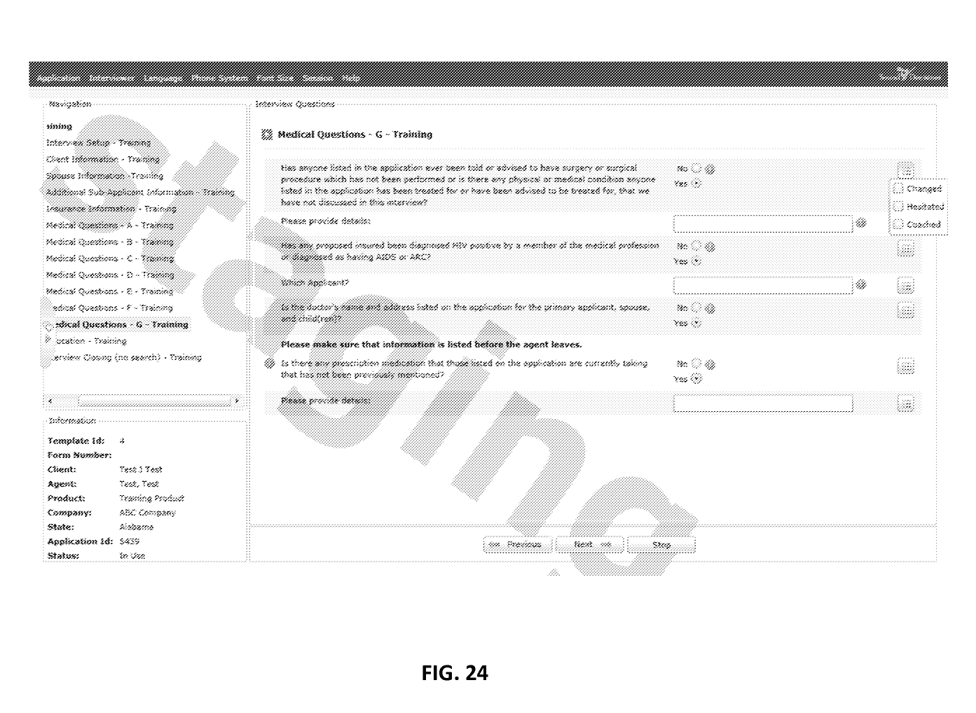

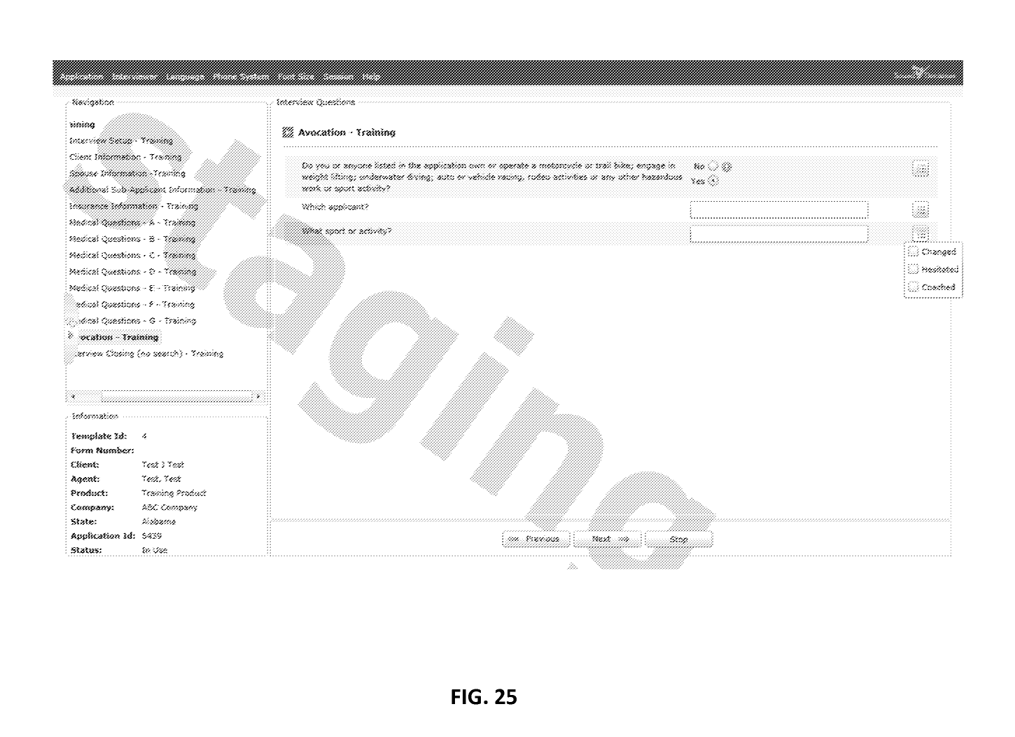

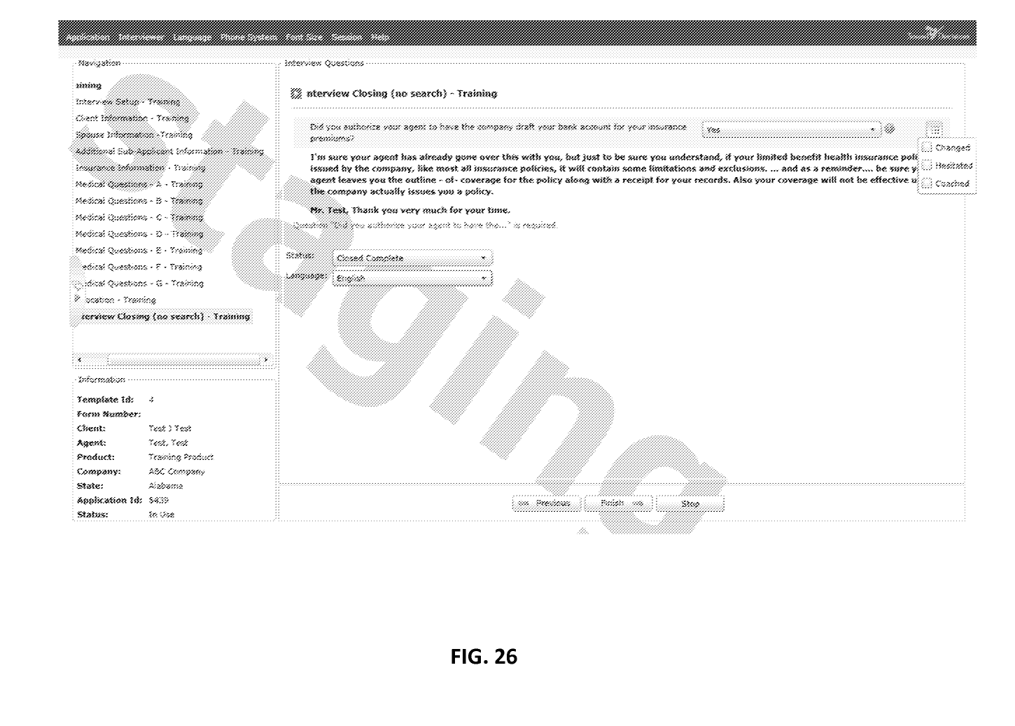

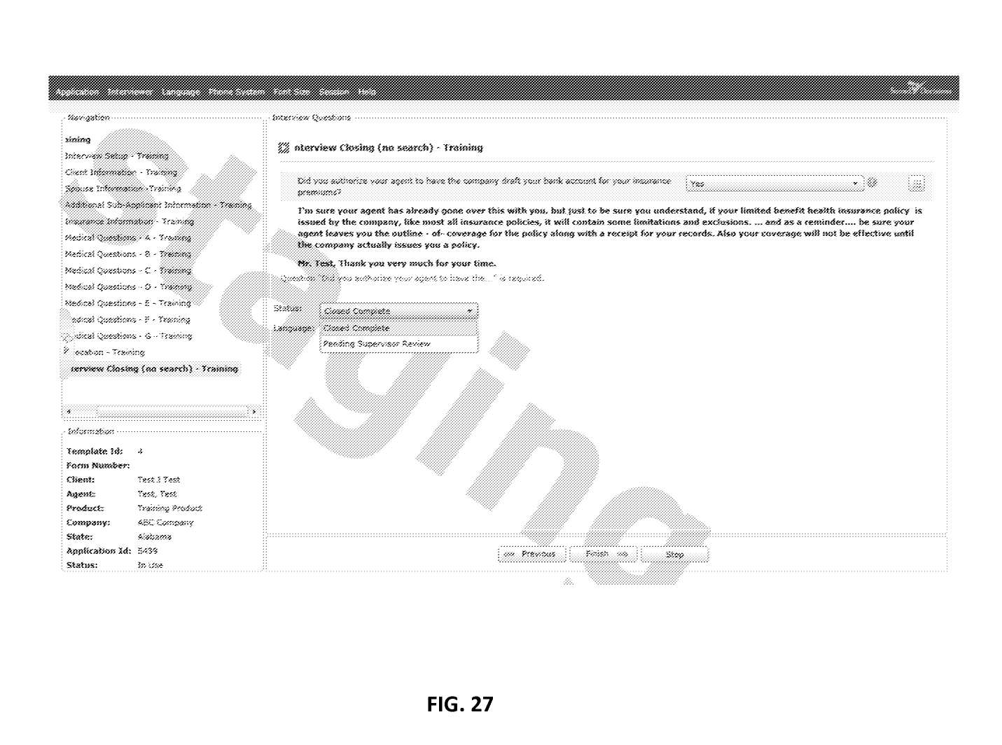

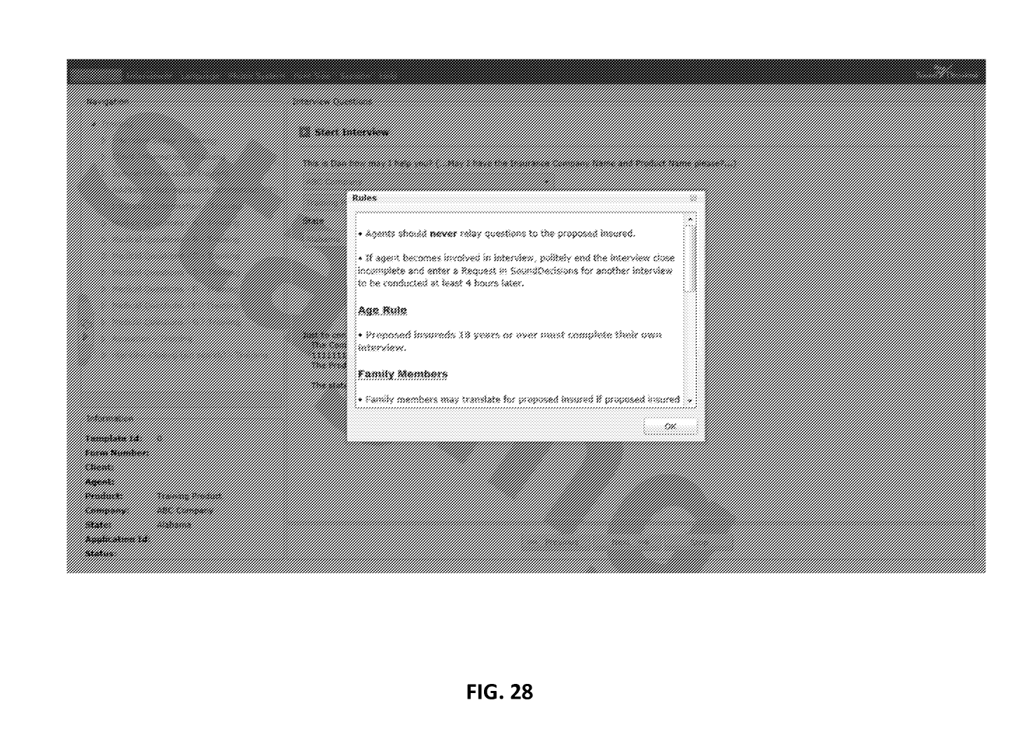

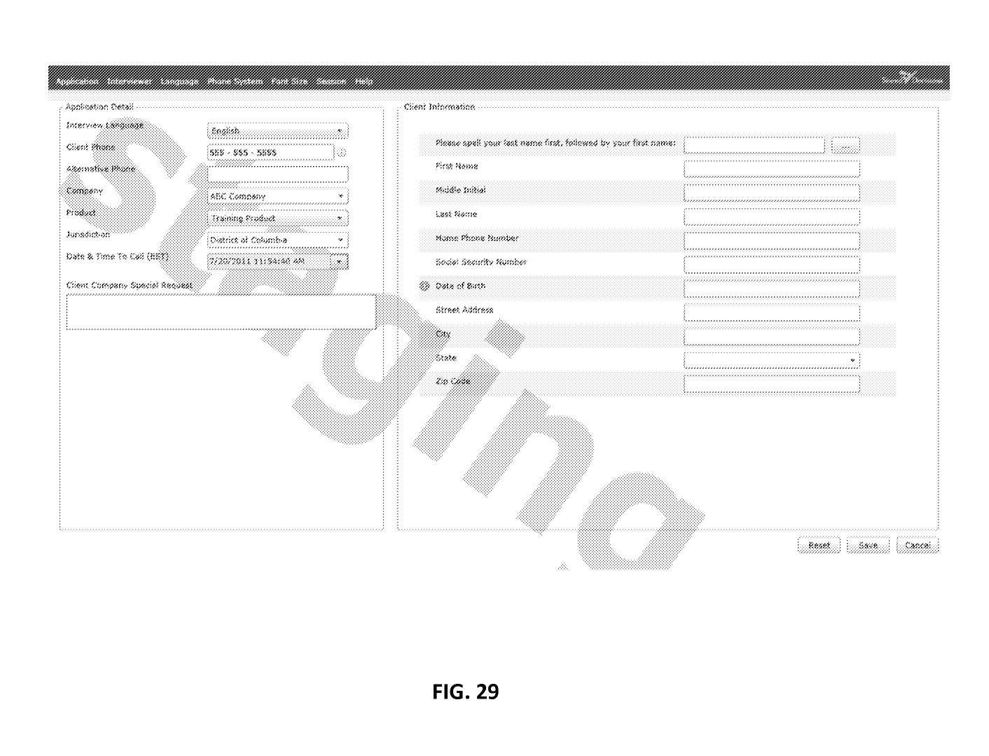

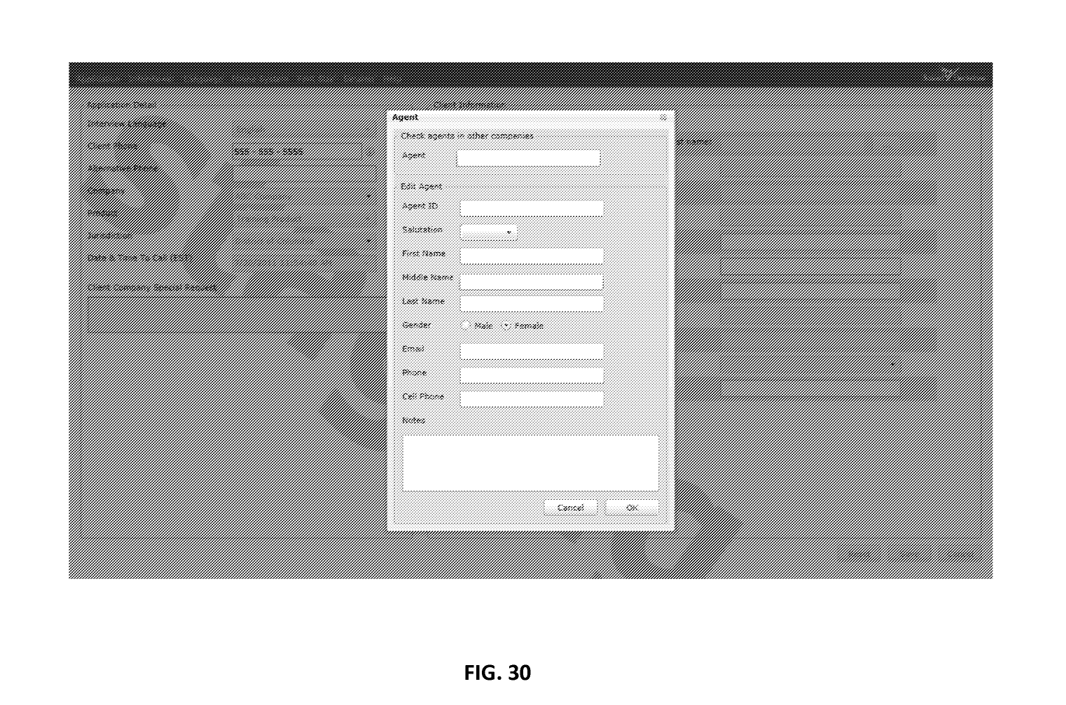

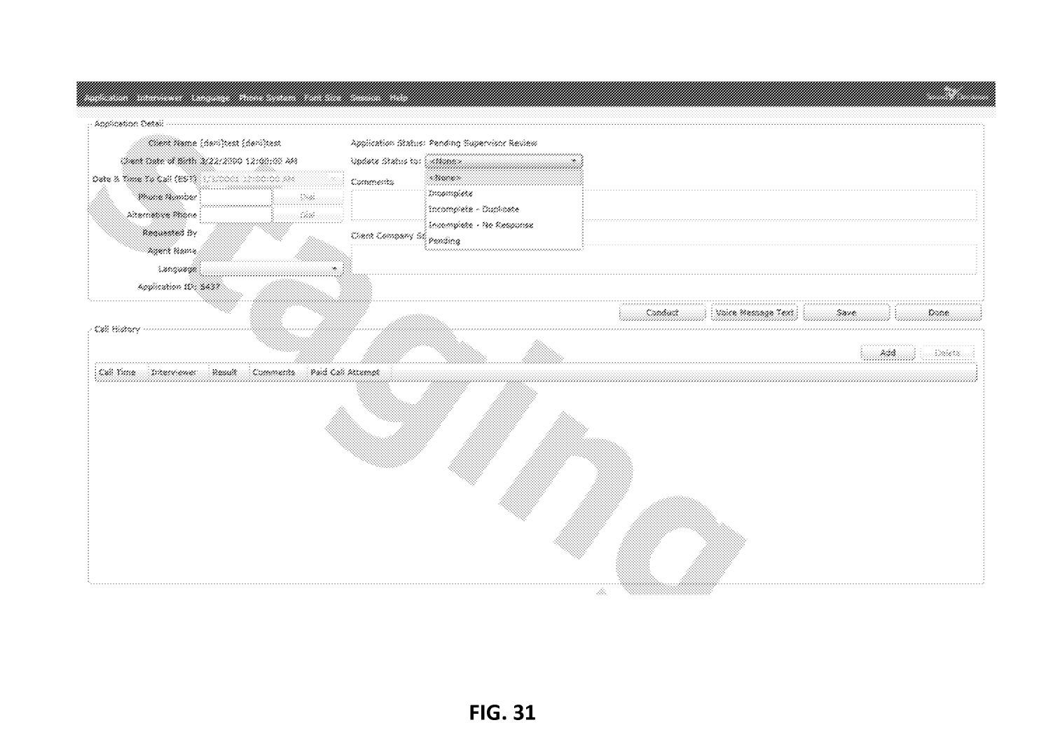

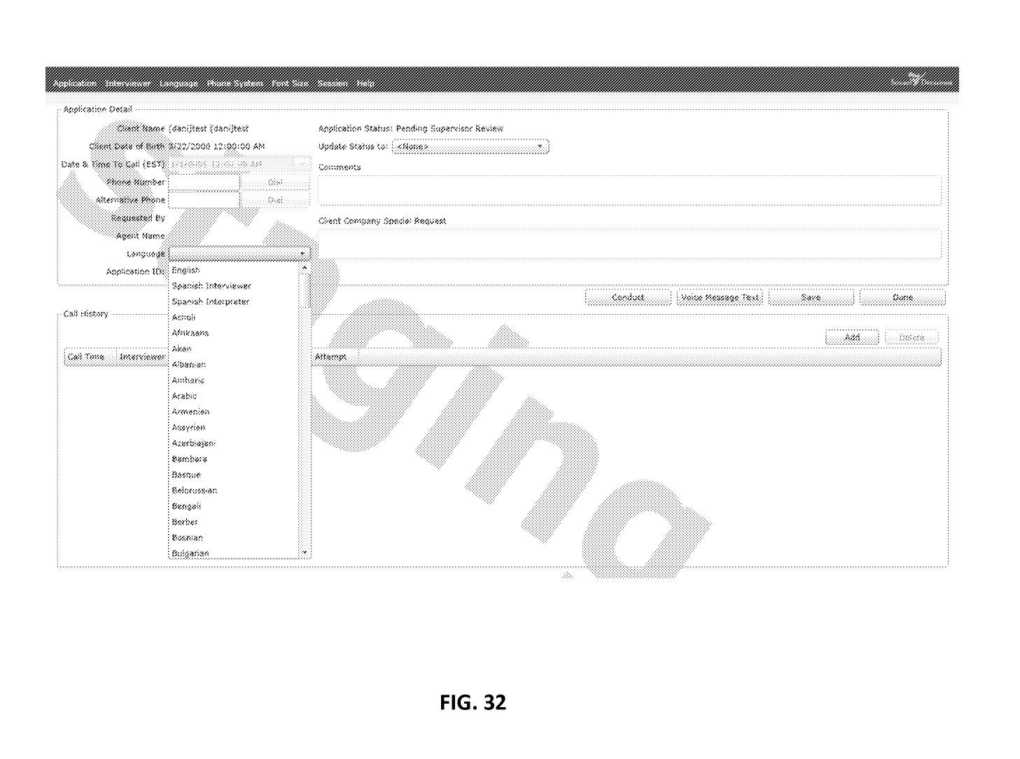

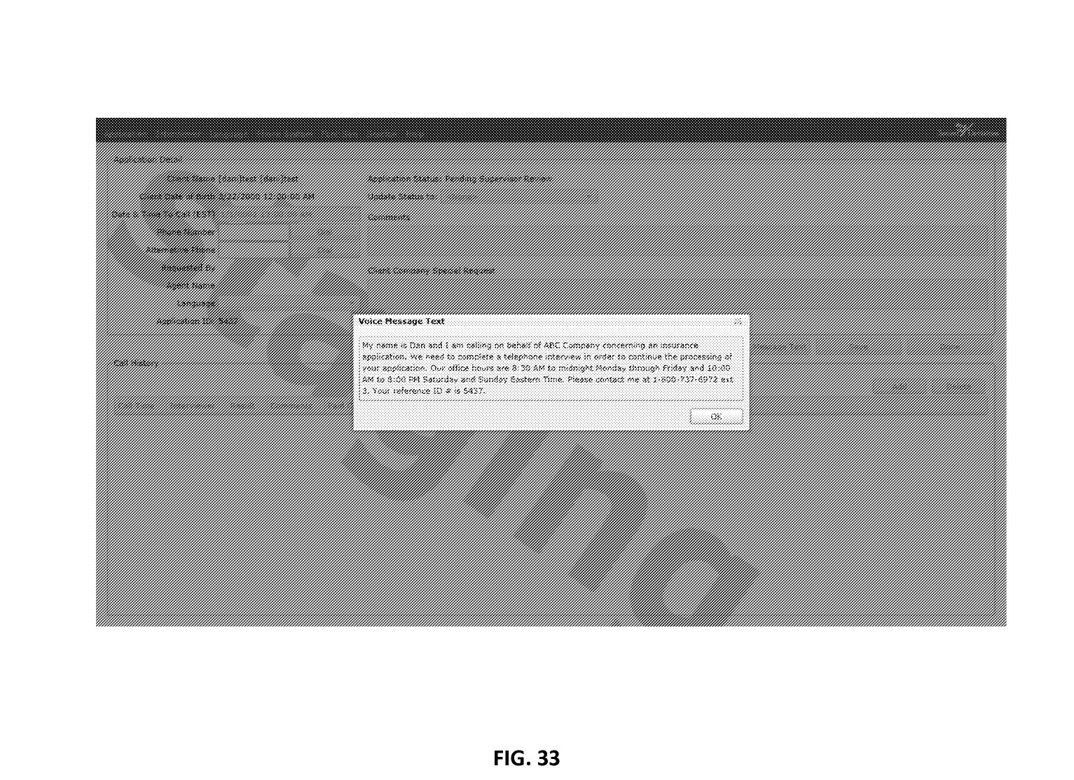

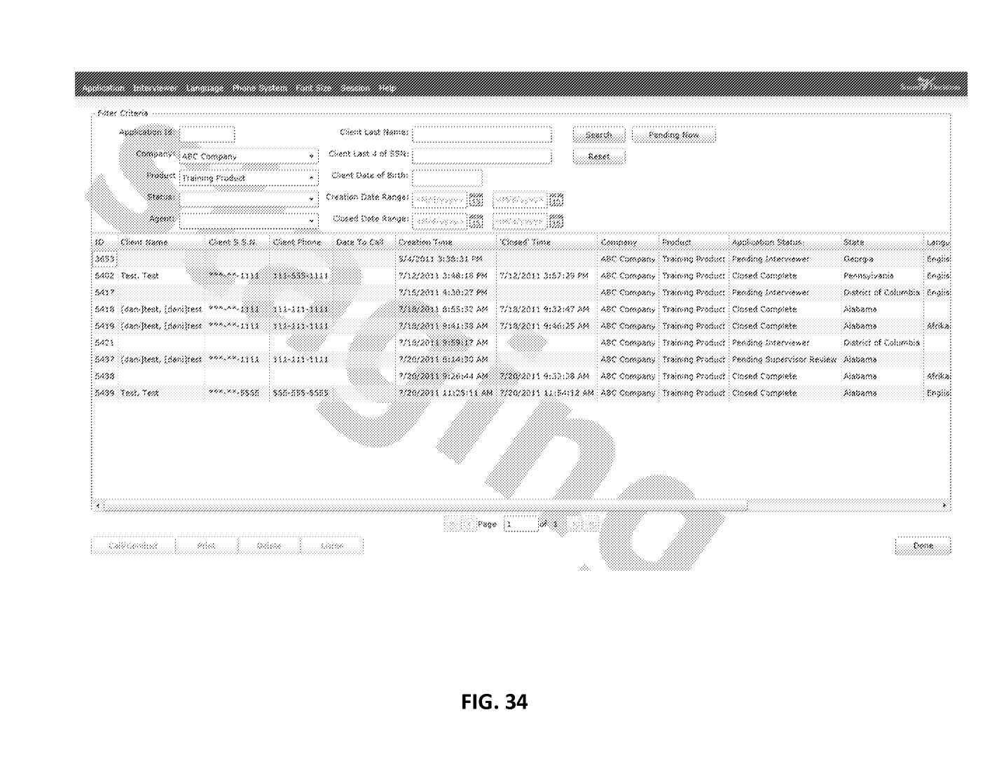

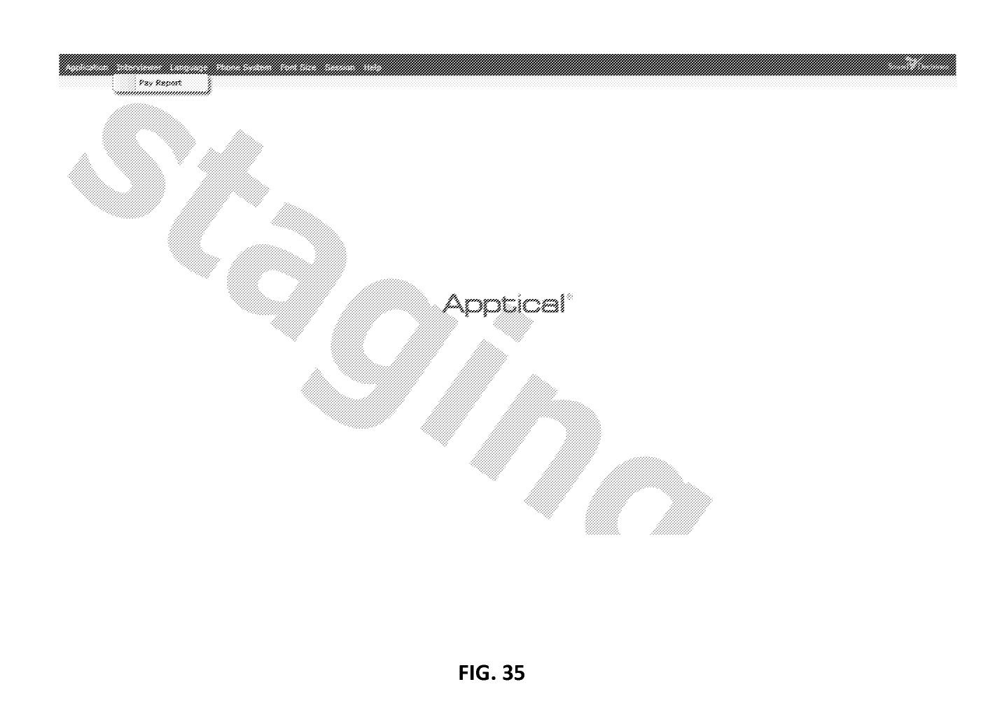

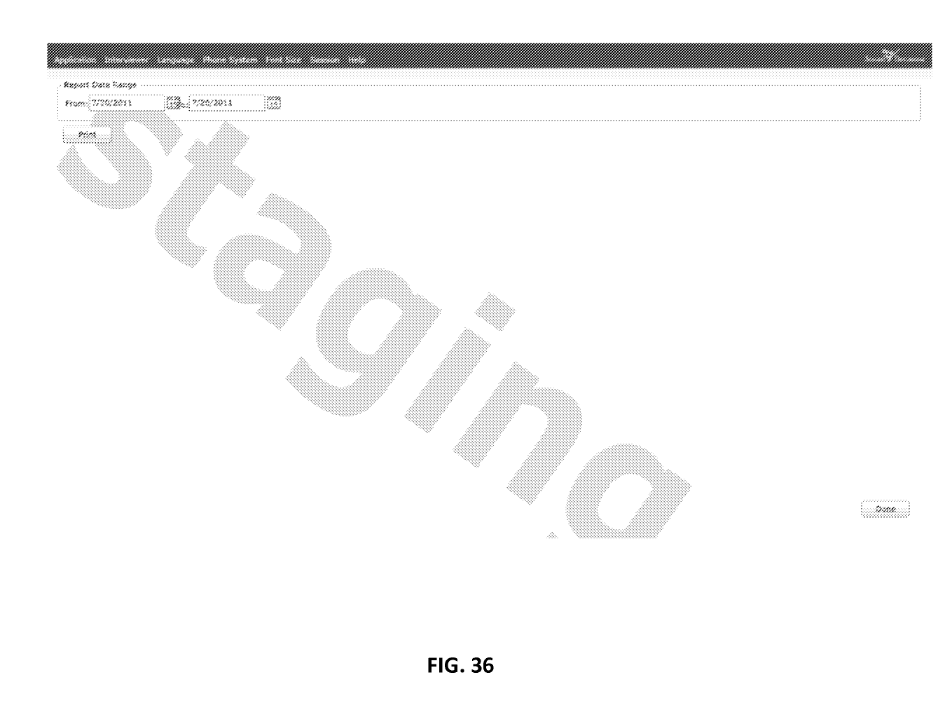

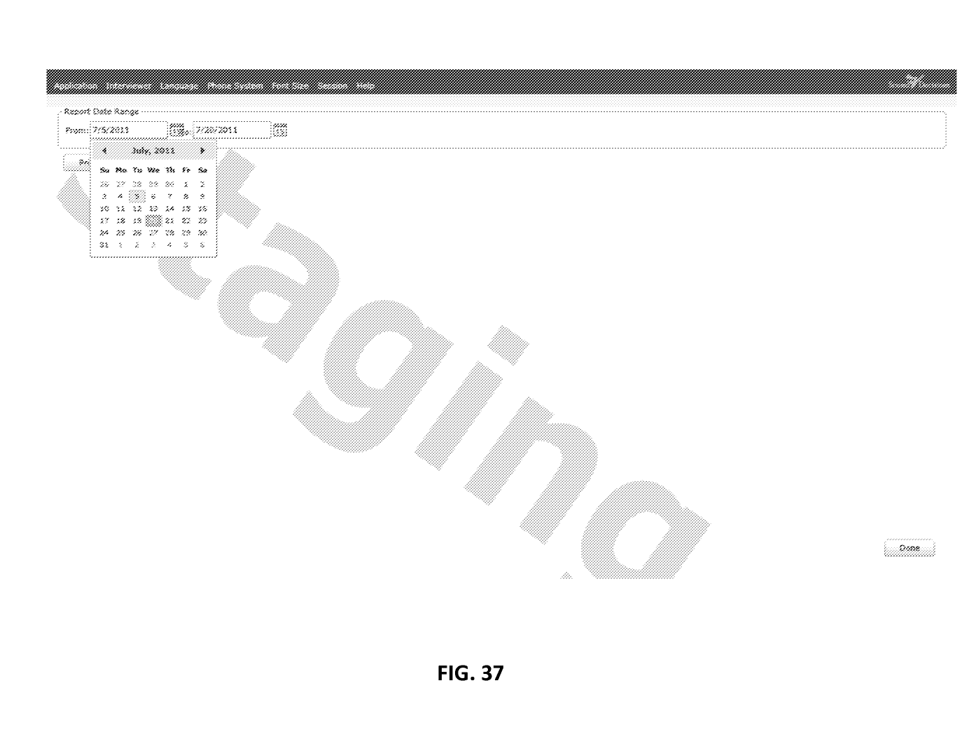

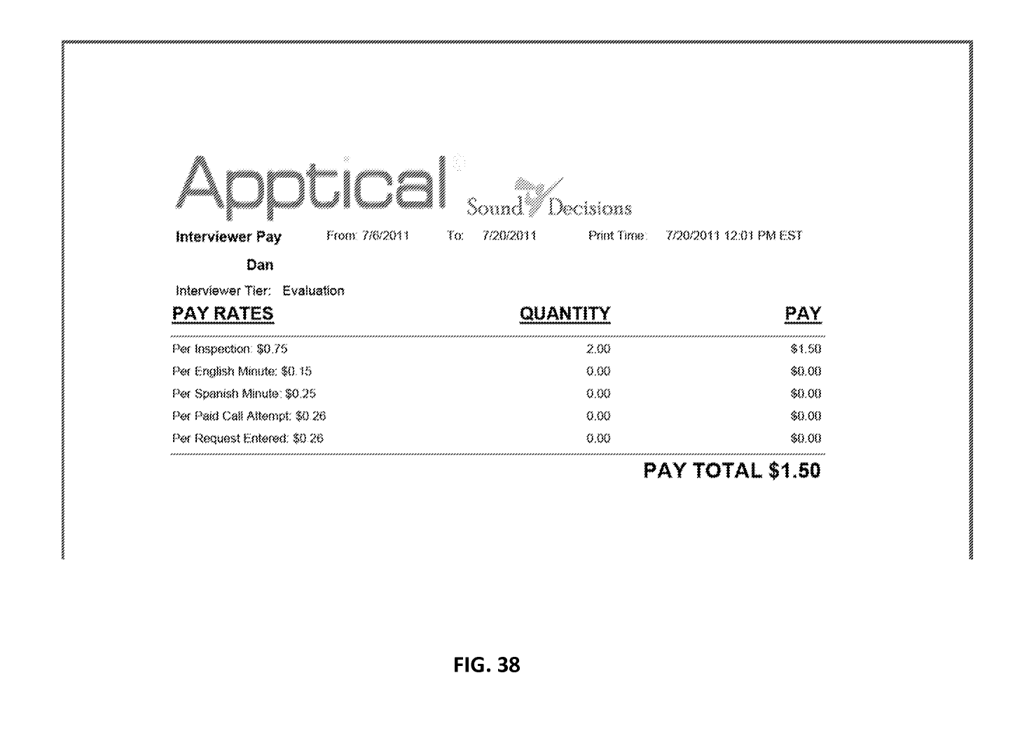

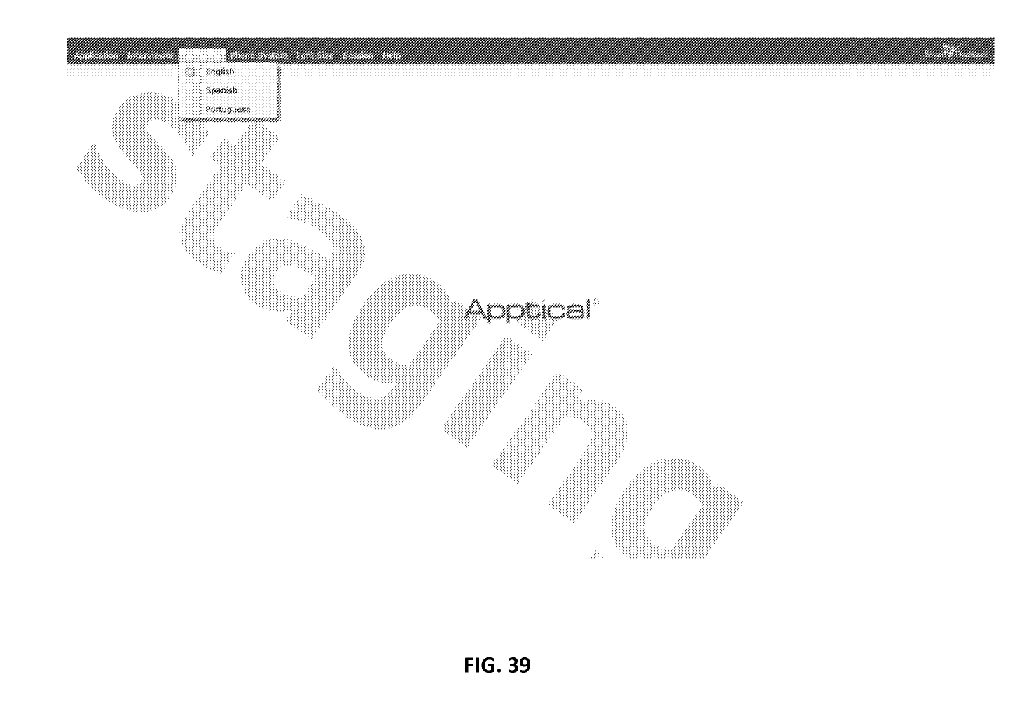

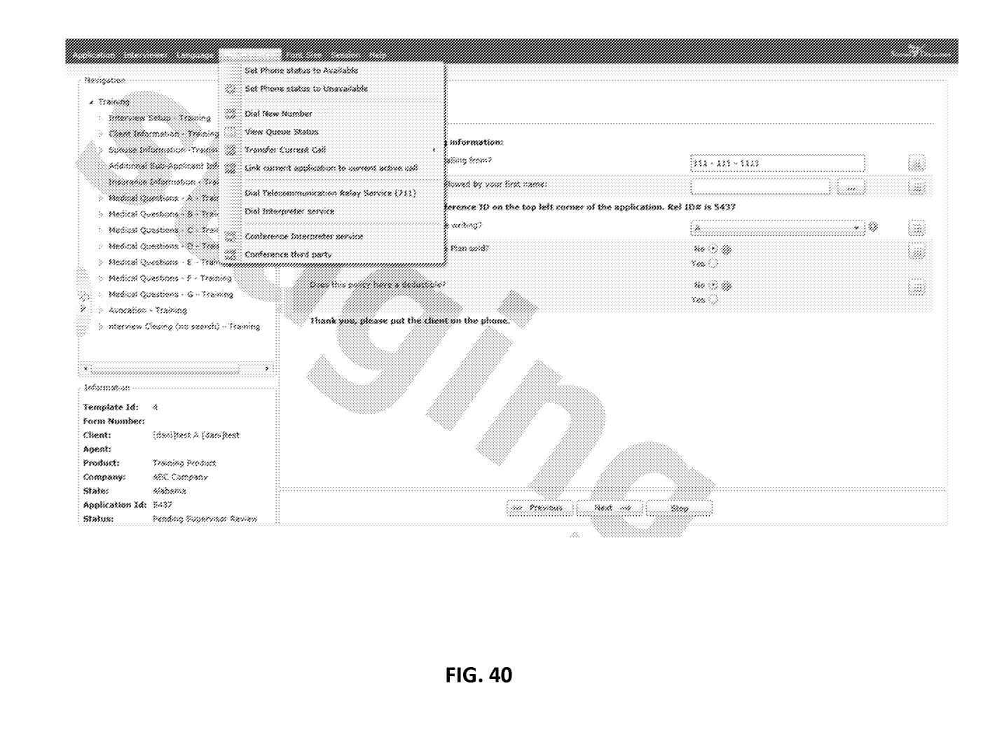

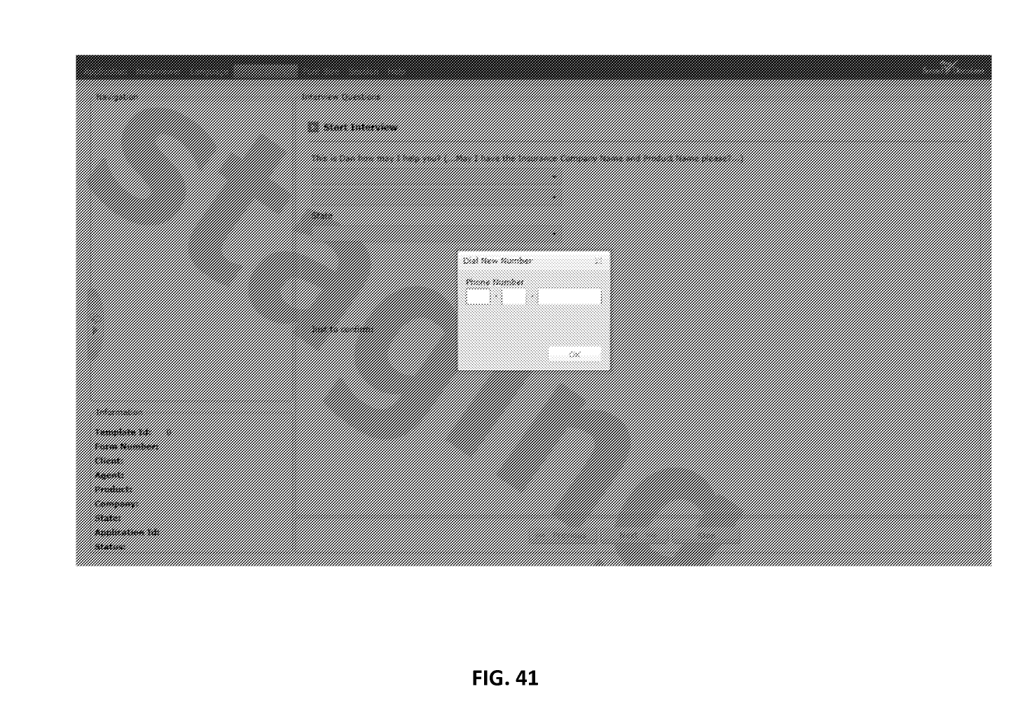

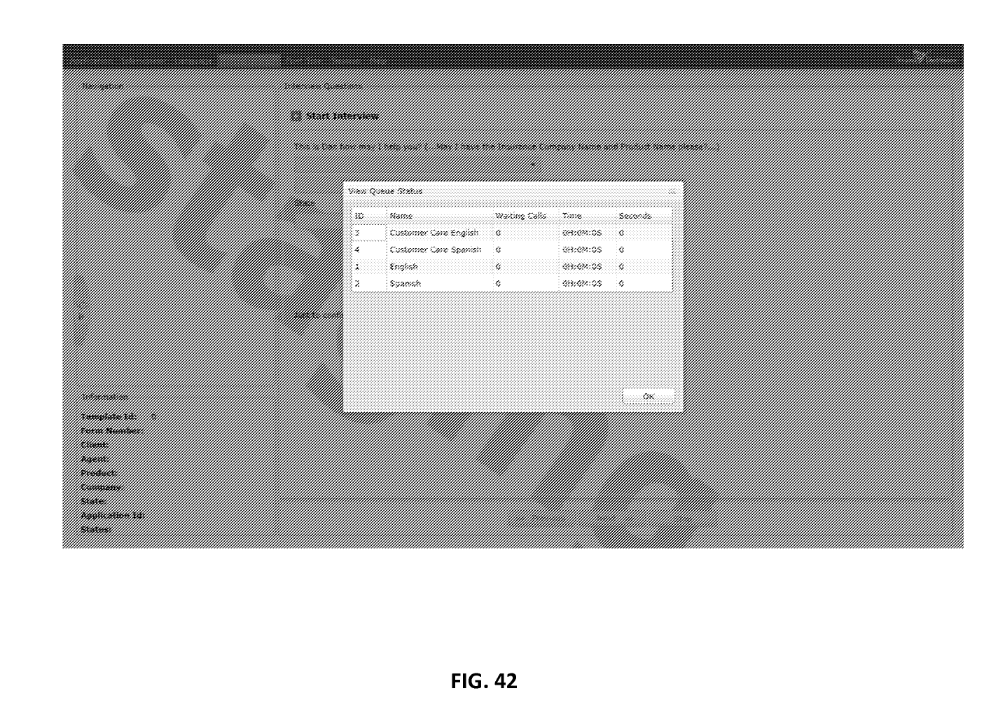

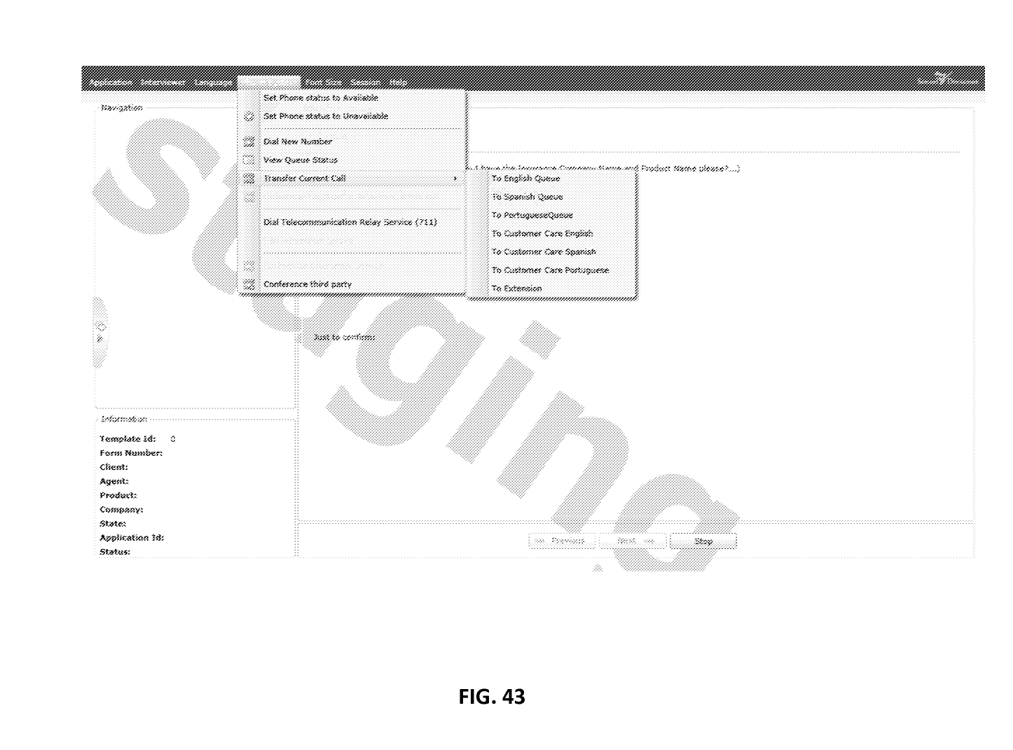

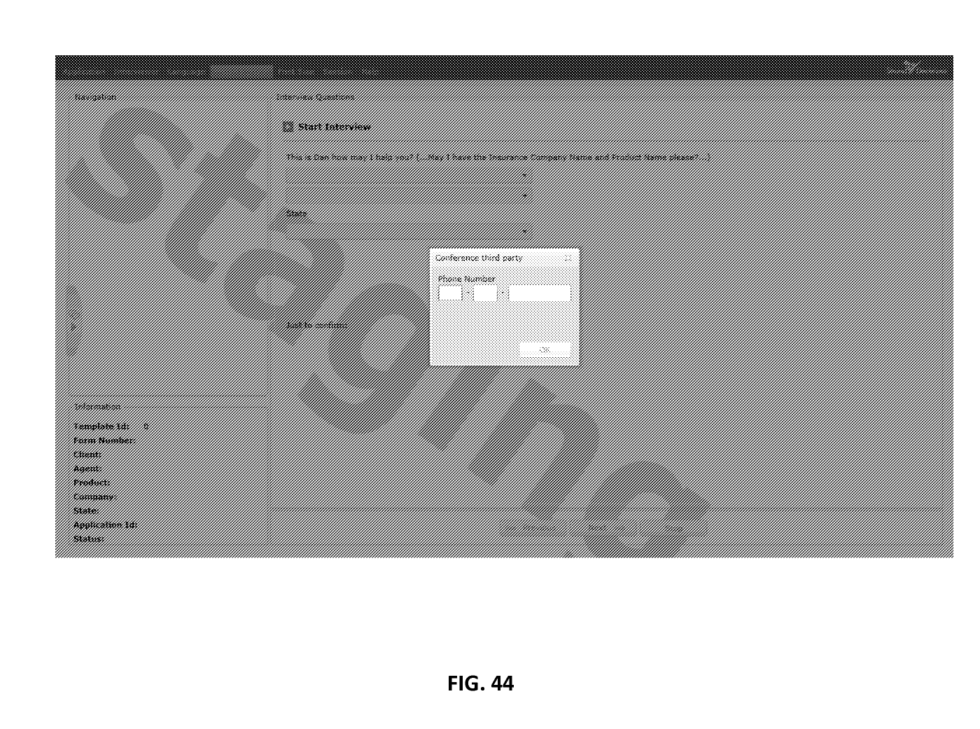

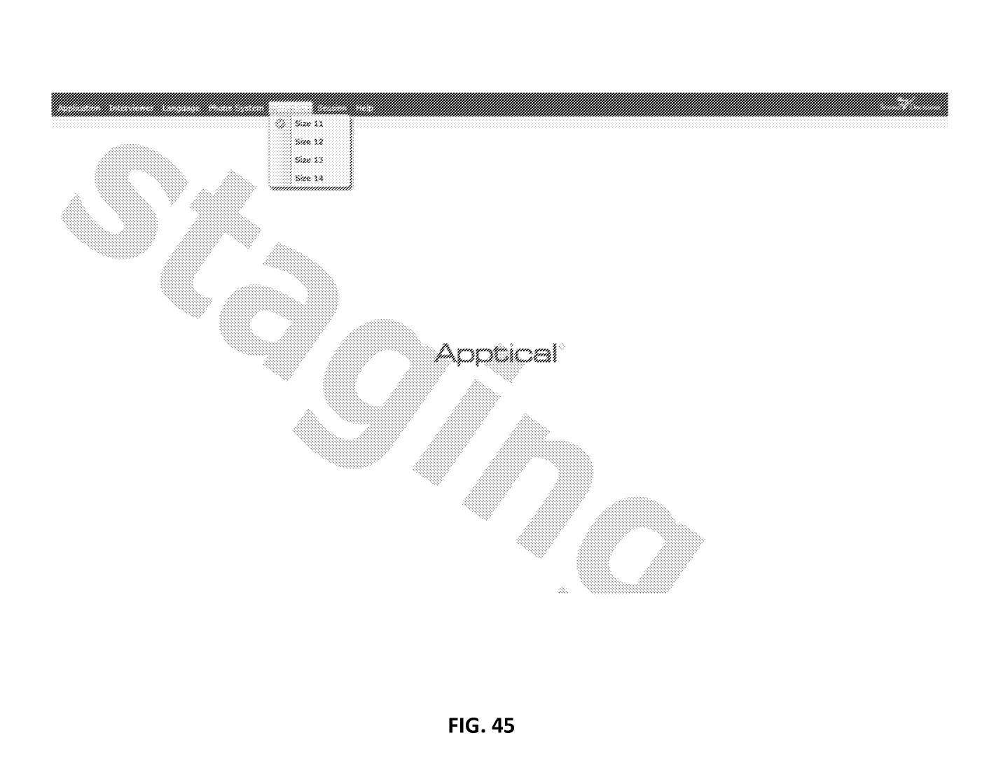

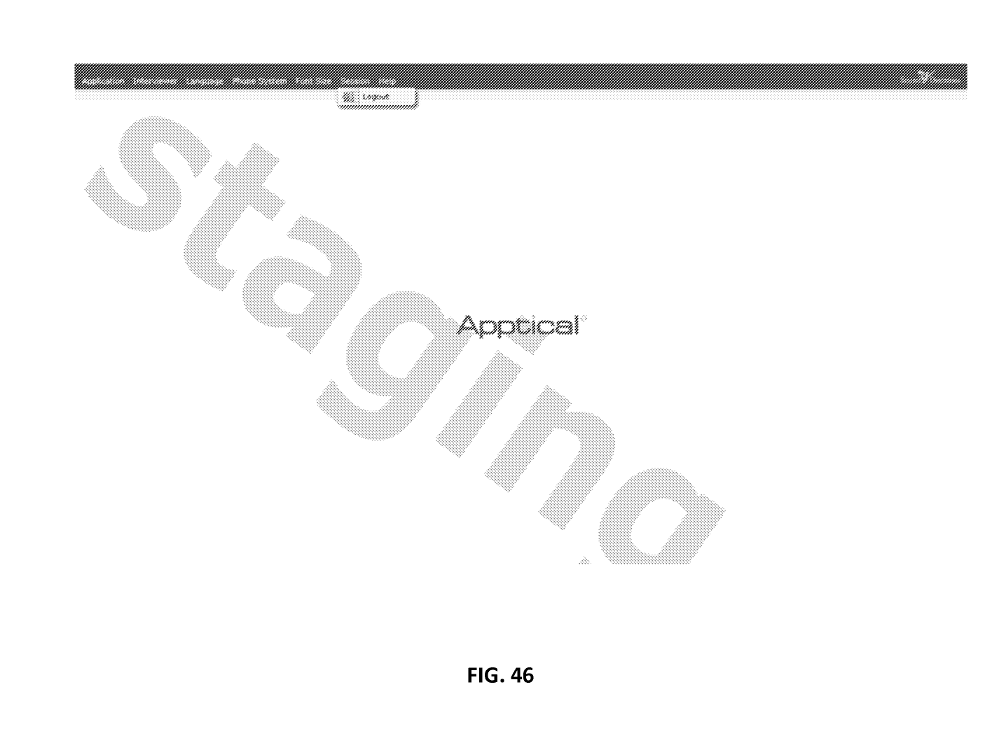

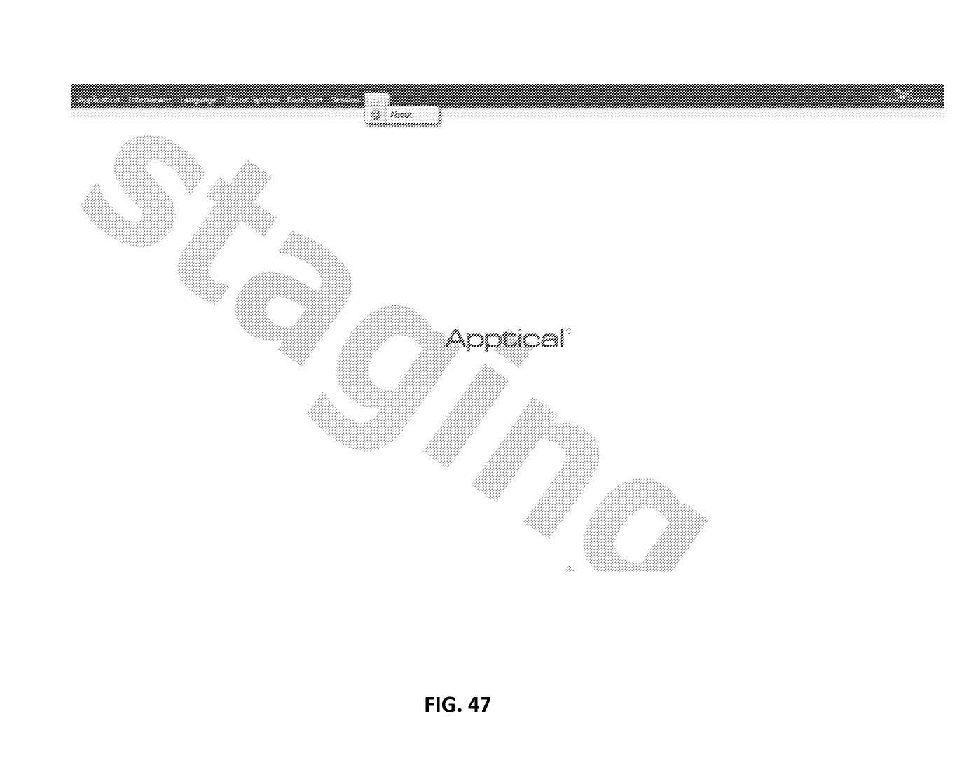

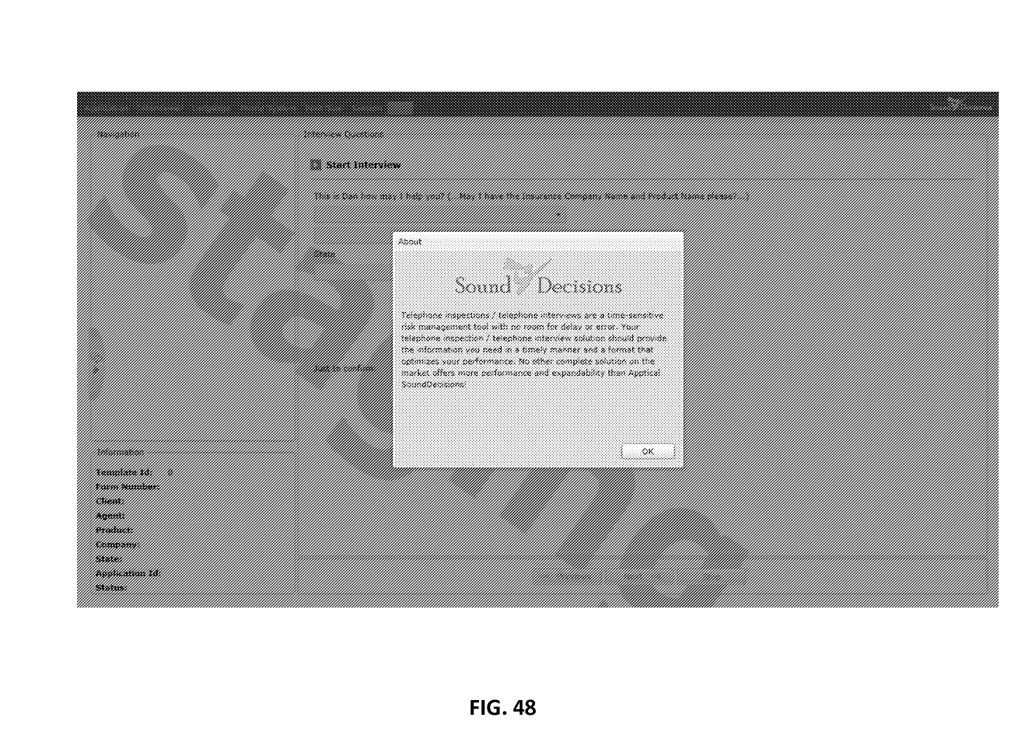

Interviewer mechanism 118 may be any appropriate mechanism that is configured to present an interviewer interface, such as the one described in relation to FIG. 4-FIG. 48, to an interviewer. For example, interviewer mechanism 118 may be a personal computer, a mobile device, etc. Interviewer mechanism 118 may communicate directly with IADMS 102, as shown in FIG. 1. For example, IADMS 102 may interact with IADMS 102 via a local network. In an alternative embodiment, IADMS 102 may be configured to communicate with IADMS 102 via computer communication network 110 and/or telephone communication network 108.

Financial institution 112 may be a credit rating agency, a bank, a credit card issuer, etc. IADMS 102 may interact with financial institution 112, for example, to determine an applicant's financial standing (e.g., to obtain credit score and/or credit report data), to determine whether the applicant has a valid checking account, etc.

Identity verification service 114 may be a service that may provide IADMS 102 with data regarding the validity of an applicant's disclosed identity information. For example, identity verification service 114 may be a background check service, a government agency, etc.

Disclosure data evaluation service 116 may be a service that evaluates disclosure data received by IADMS 102 to determine a rating, ranking, score, or other evaluation that is indicative of the applicant's qualifications for a product. For example, disclosure data evaluation service 116 may be an automated underwriting rules system, such as Merica-US® (a registered trademark of Hannover Life Reassurance Company of America).

Third-party service 120 may be a service IADMS 102 interacts with in order to enhance its functionality. Although only one instance of third-party service 120 is depicted in FIG. 1, as mentioned, this is not meant to be limiting and insurance application network 100 may include multiple third-party services 120 and each third-party service 120 may be an independent service. For example, third-party service 120 may be a customer relationship management (CRM) service, such as Salesforce.com® (a registered trademark of Salesforce.com), and IADMS 102 may communicate data with the CRM service to enable a client company to track interviews that have been, or are to be, conducted via IADMS 102. Third-party service 120 may be the Medical Information Bureau (MIB). The MIB stores insurance applicant data and IADMS 102 may employ data received from the MIB to determine if a current applicant has applied for insurance before and, if so, if his previously provided data corresponds with the presently provided data. As another example, third-party service 120 may be a medical prescription service and IADMS 102 may retrieve data regarding an applicant's medical prescription records.

### Insurance Application Data Management System

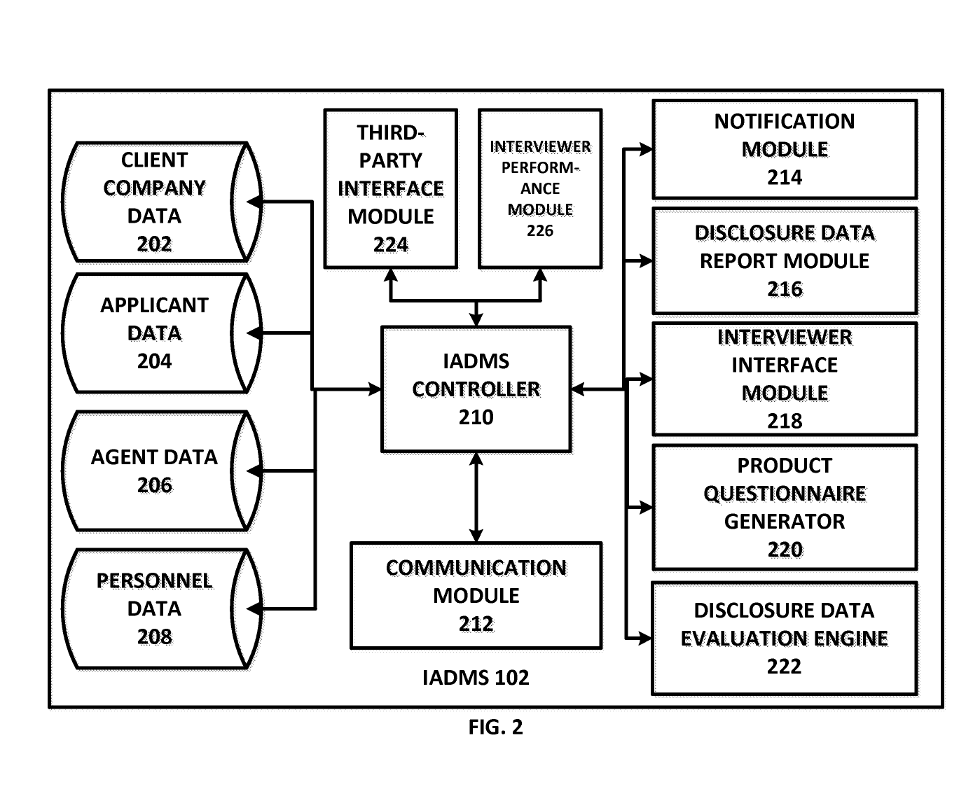

FIG. 2 depicts an architecture overview of an exemplary embodiment of IADMS 102. Those with ordinary skill in the art will recognize that the logical components set forth in FIG. 2 are merely exemplary and that other configurations that provide substantially similar functionality to that of the logical components in FIG. 2 may be used consistent with the scope of the disclosed subject matter. Although only a single instance of each component is depicted, this is for illustrative purposes only and is not to be construed as limiting. Furthermore, although each component is depicted and described as separate, this is not to be construed as limiting, and components may be combined per implementation.

### IADMS Controller and Communication Module

IADMS 102 may include IADMS controller 210 which may route data to and from IADMS 102 components. Communication module 212 may manage the receipt and transmission of data between IADMS 102 and insurance application network 100 components, routing data to and from IADMS controller 210. Communication module 212 may be enabled to transmit and receive telephony messages and/or data messages and may enable IADMS 102 to communicate via telephone communication network 108 and/or computer communication network 110.

### Data Stores

IADMS 102 may store data associated with one or more entities that use the system, such as client company data 202, applicant data 204, agent data 206, and personnel data 208. Such data may be maintained in one or more data stores and may be maintained in association with one or more appropriate accounts. Client company data 202 may include client company names contact information (e.g., mailing address, email address, Web address, phone number, contact personnel data, etc.), product requirement data, etc. Applicant data 204 may include information associated with one or more applicants, such applicant names, contact information, disclosure data, product information (e.g., data regarding products applied for), product application decision data, etc. Agent data 206 may include information associated with one or more agents that use or have used IADMS 102. Agent data 206 may include contact information, client company information (e.g., data regarding a client company the agent represents), etc. Agent data 206 may also include an agent identifier, which may be an assigned reference code, a phone number, or any other data that may be employed to automatically identify the agent. Personnel data 208 may include data associated with IADMS personnel, such as interviewers, administrators, etc. Personnel data 207 may include a login credentials (e.g., usernames, passwords, etc.), performance data, authorization data, contact information, etc. As detailed further below, contact information may include, for example, an email address or phone number that is to be employed to notify the employee of a pending interview.

### Product Questionnaire Generator

Product questionnaire generator 220 may enable IADMS 102 to generate a product questionnaire based upon product requirement data provided by a client company. In one embodiment, product questionnaire generator 220 is configured to present a user interface that enables an IADMS employee to input product requirement data. The user interface may present the user with one or more data entry fields that may be suitable to various products, thereby eliminating the need for custom programming for individual products. Furthermore, the user may translate product requirement data, such as questions or statements, into one or more foreign languages. In an alternate embodiment, product questionnaire generator 220 is configured to receive application data from a data file (e.g., one provided by a client company). Once product questionnaire generator 220 has received product requirement data, it may create a product questionnaire to be presented to an interviewer via an interviewer interface.

A product questionnaire may be designed to ensure that the interviewer receives all necessary disclosure data and relays all necessary product requirement data. The product questionnaire may include one or more pieces of a script for the interviewer to read to the applicant (or agent) to prompt the interviewer to request all necessary disclosure data, to relay all necessary legal language to the applicant and/or agent, etc. The product questionnaire may include one or more reminders to ensure that the interviewer conducts the interview accurately and legally. For example, the product questionnaire may inform the interviewer that if the applicant is under 18 then the disclosure data must be provided by a parent or guardian.

In addition to structured data fields and options, the product questionnaire may include one or more free-form entry fields that may enable the interviewer to input any supplemental information. The product requirement data provided by the client company may include one or more special questions an interviewer must ask and the interviewer may be prompted to input the answers to these questions in the free-form entry field. Additionally, a product questionnaire may include a free-form entry field so that the interviewer may include any additional information he or she feels relevant to the interview. For example, the interviewer may indicate how the interview went in general, positive or negative aspects of the applicant or agent during the interview, etc.

### Notification Module

IADMS 102 may include notification module 214, which may be configured to notify one or more interviewers of a pending interview. An interview may be a transaction of information that occurs between an interviewer and one more interviewees, such as an applicant and an agent, typically to obtain disclosure data. When an interviewer logs into IADMS 102, he or she may indicate his or her availability to receive interviews and, once logged in, the interviewer may toggle his or her availability. An interviewer may register contact data (e.g., such as a phone number, an email address, etc.) in order to receive a pending interview notification. When IADMS 102 receives an interview request, notification module 214 may transmit a notification message (e.g., a phone, text, email message, etc.) to the interviewer. The notification message may inform the interviewer that he or she needs to respond to the pending interview. In one scenario, notification module 214 may initiate a response timer upon issuing the notification message and an interviewer may be requested to respond within a time limit (e.g., thirty seconds). If the pending interview is not responded to prior to the time limit being reached, a message may be issued to a supervisor and/or other interviewers, notifying them that the pending interview has not be responded to in the appropriate amount of time.

### Interviewer Interface Module

Interviewer interface module 218 may be configured to present one or more product questionnaires via an interviewer interface, such as the one depicted in FIG. 4-FIG. 48, via interviewer mechanism 118. For example, interviewer interface module 218 may be a Web interface and may enable interviewer mechanism 118 to present product questionnaires via a Web browser.

### Disclosure Data Evaluation Engine

Disclosure data evaluation engine 222 may enable IADMS 102 to analyze received disclosure data to determine an evaluation. The evaluation may be employed by IADMS 102 and/or a client company to determine whether the associated applicant is eligible for a product, the applicant's cost for receiving the product, etc. Disclosure data evaluation engine 222 may calculate the rate that the applicant will be required to pay to the client company for the product in light of the evaluation.

### Third-Party Interface Module

Third-party interface module 224 may enable IADMS 102 to interact with one or more third-party services 120. In one scenario, third-party interface module 224 may communicate data to a CRM service regarding the status of an interview, such as whether it has been attempted and/or completed, the time and date it has been attempted and/or completed, the result of the interview (e.g., whether the applicant was eligible, the cost of the product for the applicant, etc.), etc. In another scenario, third-party interface module 224 may enable IADMS 102 to interact with the MIB and communicate and receive applicant data. For example, IADMS 102 may request applicant data in order to determine if currently provided disclosure data is valid.

### Disclosure Data Report Module

Once IDMS 102 has received disclosure data from an applicant and obtained an evaluation of the disclosure data (e.g., from disclosure data evaluation service 116 and/or disclosure data evaluation engine 222), disclosure data report module 216 may generate an applicant report including the applicant data, the evaluation, etc, and format that report so that it may be useful to an external entity, such as a client company. For example, disclosure data report module may generate an applicant report in a format (e.g., XML) employable by client company system 104, such as in ACORD format or HIPAA format.

### Interviewer Performance Module

Interviewer performance module 226 may enable a user, such as an administrator or interviewer, to view data regarding interviewer pay, performance, etc. For example, interviewers may be paid based upon one or more factors, such as the number of interviews completed, the duration of an interview (e.g., an interviewer may receive additional pay if an interview goes over a time limit), etc. Furthermore, an interviewer may be rewarded or penalized for response time. Interviewer performance module 226 may enable the creation of reports or other suitable data outputs.

### Disclosure Data Receipt and Analysis

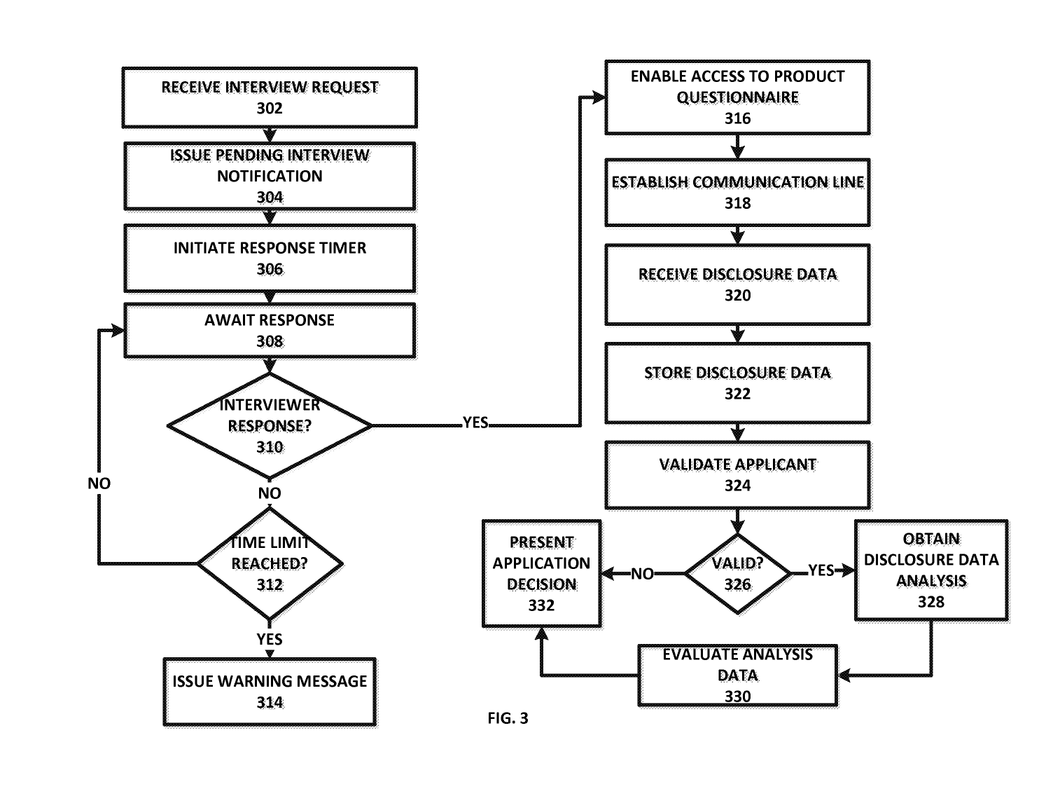

FIG. 3 depicts a flowchart of an exemplary process of a receiving and processing disclosure data via IADMS 102. IADMS 102 may receive an interview request from application mechanism 106 (step 302). The individual using application mechanism 106 may be an agent or an applicant. In one scenario, an agent may initiate the interview request and then request that the applicant provide disclosure data directly. The interview request may be received as a telephony message or a data message. The description herein is typically described in regards to a telephony-based scenario, but this is for illustrative purposes only and is not to be construed as limiting. Once IADMS 102 receives the interview request, it may issue a pending interview notification to one or more interviewers (step 304) and initiate a response timer (step 306) and await a response (step 308). As mentioned, an interviewer may register a phone number, an email address, etc with IADMS 102 and IADMS 102 may transmit an automated phone message, an automated text message, or an automated email to the interviewer as would be appropriate. The notification message may inform the interviewer that he needs to respond to the pending interview request prior to the response timer reaching its time limit. Once IADMS 102 has issued the notification message, it may determine if it has received an interviewer response (step 310). If the IADMS 102 receives an interviewer response, IADMS 102 may enable the interviewer to access a product questionnaire, such as via the interviewer interface depicted in FIGS. 4-48 (step 316). If an interviewer has not responded, IADMS 102 may determine if the time limit has been reached (step 312). If the time limit has not been reached, IADMS 102 may continue to await an interviewer response (step 308). If the time limit has been reached, IADMS 102 may issue a warning message to a supervisor and/or other interviewers, notifying them that a pending interview has not be responded to in the appropriate amount of time (step 314).

Once an interviewer has responded to the pending interview notification, IADMS 102 may enable the interviewer to access a product questionnaire, such as via the interviewer interface depicted in FIGS. 4-48 (step 316). The interviewer may select the appropriate product questionnaire based upon information received from the agent or applicant, such as by client company name and the applicant's residence location (e.g., state of residence). The received interview request may include an agent identifier and IADMS 102 may determine if its records include an associated agent account. If so, IADMS 102 may access data from the agent account and populate the product questionnaire with the agent's information (e.g., his name, his company, etc.).

IADMS 102 may establish a communication line between the interviewer and application mechanism 106 (step 318). For example, interviewer mechanism 118 may include a telephony device and the interviewer may speak with the agent and/or applicant via telephone communication network 108. In an alternate embodiment, interview mechanism 118 may include a data messaging mechanism and the interviewer may communicate with the agent and/or applicant via computer communication network 110 (e.g., via instant messaging, voice over IP (VoIP) or Internet chat). In one scenario, the interviewer may communicate with the agent to ascertain the client company involved, the appropriate product, and the relevant locality data (e.g., the applicant's state of residence). Once this has been obtained, IADMS 102 may receive the applicant's disclosure data as the interviewer inputs the data received from the applicant into the product questionnaire (step 320). The interviewer may follow the product questionnaire to ensure that all proper disclosure data is obtained.

Once sufficient disclosure has been received, IADMS 102 may store the received disclosure data (step 322) and use information included in the disclosure data to validate the applicant (step 324). In one embodiment, IADMS 102 may communicate one or more elements of disclosure data to identity verification service 114, such as a background checking service that determines the validity of the received data. For example, identity verification service 114 may determine if the name, address, and social security number provided by the applicant correspond with its own records. IADMS 102 may also communicate received financial information included with the disclosure data to a financial institution 112, such as a bank, credit agency, etc, to determine whether the applicant has a valid financial account (e.g., an active checking account). Once such validation information has been obtained, IADMS 102 may determine if the applicant has been validated (step 326). If the applicant is not deemed as a valid applicant, IADMS 102 may present the interviewer with the application decision (step 332); in this case indicating that the applicant has been declined. The interview may relay the decision to the individual employing application mechanism 106 (e.g., the applicant and/or the agent). If the applicant is deemed a valid applicant, IADMS 102 obtain an analysis of the disclosure data (step 328). In one scenario, IADMS 102 may include its own disclosure data evaluation engine 222. IADMS 102 may access data maintained by third-party service 120, such as the MIB, to determine the accuracy of the disclosure data. Additionally, or alternatively, IADMS 102 may communicate one or more elements of the disclosure data to one or more external disclosure data evaluation services 116. Once the disclosure data evaluation engine 222 and/or the disclosure data evaluation service 116 has provided analysis data, IADMS 102 may evaluate the analysis data to determine whether the analysis data indicates the applicant qualifies for the insurance product and, if so, any exceptions, exclusions, or requirements (if any) and/or the cost of the product for the application (step 330). For example, IADMS 102 may calculate the rate the applicant will be required to pay if he wishes to obtain the product. IADMS 102 may present the application decision (step 332). The application decision may include information regarding exceptions, exclusions, requirements, the calculated rate, etc. The interviewer may share the application decision with the individual via application mechanism 106.

IADMS 102 may present the associated client company (and optionally the agent) with an application report. As mentioned, the report may be provided in a format employable by the client company, such as an ACORD XML report. The application report may be an underwriting report, indicating the applicant's qualifications (or lack thereof) for the client company's product.

### Interviewer Interface

FIG. 4-FIG. 48 depict an exemplary interviewer interface for receiving disclosure data according to an embodiment. The interviewer interface may be configured so that the interviewer may not proceed to a subsequent step of the product questionnaire until he or she has obtained the necessary data to complete the current step. Having the interviewer interface configured in this manner may reduce or eliminate interviewer training time as the interviewer interface may guide the interviewer through the necessary questions each time he or she accesses the product questionnaire. Furthermore, the interviewer need not be retrained if changes are made to a product questionnaire, as the interviewer interface may present only the most recent version of the product questionnaire for the associated product.

For one or more data fields included in a product questionnaire, the interviewer interface may enable the interviewer to indicate an assessment of the applicant's behavior, such as the applicant's perceived honesty, when responding. The interviewer may indicate whether the applicant changed his initial response, hesitated with his response, appeared to have been coached with his response, etc.

The interviewer interface may enable the interviewer to open multiple product questionnaire screens concurrently. This may allow the interviewer to interview more than one applicant during the same interview (i.e., rather than conducting a separate interview). For example, the interview may receive disclosure data from a husband and wife during the same interview. This allows the interviewer to ask the same question of both parties at the same time, thereby reducing the time required for all parties involved.

The interviewer interface may enable the interviewer to select the language of the product questionnaire during the interview as needed. For example, the interviewer may initially view the product questionnaire in English, switch to Spanish when speaking with a Spanish-applicant, and then switch back to English to speak with an English-speaking agent. Additionally, if the interviewer cannot speak the required language, he or she may transfer the interview to a queue for interviewers proficient in the required language.

The interviewer interface may include various functions to assist with the interview process. For example, the interviewer interface may enable the interviewer to teleconference with a third party, play a pre-recorded audio clip, access wait time information, access pending interview information, change a phone number to be dialed, change interviewer status (e.g., available or not available), etc. Such functions may be accessed by selecting an on-screen button, selecting an option from a drop-down menu, etc.

The interviewer interface may also include an indicator to present the interviewer with the name or title of the person with which he is communicating. For example, the interviewer interface may indicate whether the interviewer is speaking with the agent, the applicant, or both.

### Mobile Application

In one embodiment, an agent may initiate an interview request via a mobile application (i.e., an “app”) installed on a mobile device (e.g., a smartphone). By selecting the mobile app, the agent may transmit an interview request to IADMS 102. When the request is responded to by an interviewer, he or she may be presented with the agent's phone number and/or IADMS 102 may automatically call the appropriate phone number. The app may enable an agent to access the current wait time for an interviewer response (e.g., ten minutes, immediate, etc.). In addition to sending an interview request, the app may also enable an agent to initiate communication with an interviewer, such as by automatically placing a call to IADMS 102 or by initiating data messaging interface (e.g., email, instant messaging, etc.).

A system and method for enabling the receipt of data for insurance application has been illustrated. It will be appreciated by those skilled in the art that other variations of the disclosed subject matter will be possible without departing from the scope of the disclosure.

These and other aspects of the present invention will become apparent to those skilled in the art by a review of the preceding detailed description. Although a number of salient features of the disclosed subject matter have been described above, the invention is capable of other embodiments and of being practiced and carried out in various ways that would be apparent to one of ordinary skill in the art after reading the disclosure. Therefore, the description should not be considered to be exclusive of these other embodiments. Also, it is to be understood that the phraseology and terminology employed herein are for the purposes of description and should not be regarded as limiting.

What is claimed is:

1. A system, method, and computer readable medium as disclosed above.
